(19) United States
(12) Patent Application Publication
(10) Pub. No.: US 2026/0172097 A1
(43) Pub. Date: Jun. 18, 2026

(54) METHOD AND APPARATUS FOR PERFORMING COMPRESSION AND RECONSTRUCTION OF CSI BASED ON AI MODEL IN WIRELESS COMMUNICATION SYSTEM

(71) Applicant: Samsung Electronics Co., Ltd., Suwon-si (KR)

(72) Inventors: Jungsuk BAIK, Suwon-si (KR); Bongsung SEO, Suwon-si (KR); Min JANG, Suwon-si (KR); Jeonghyeon JANG, Suwon-si (KR); Byeonghun HWANG, Suwon-si (KR)

(21) Appl. No.: 19/047,020

(22) Filed: Feb. 6, 2025

(30) Foreign Application Priority Data
Dec. 13, 2024 (KR) 10-2024-0185587

(51) Int. Cl. H04B 7/06; H04L 5/00

(52) U.S. Cl. CPC H04B 7/0663; H04L 5/0051

(57) ABSTRACT

The disclosure relates to a 5th generation (5G) communication system or a 6th generation (6G) communication system for supporting higher data rates beyond a 4th generation (4G) communication system, such as long term evolution (LTE). A method performed by user equipment in a wireless communication system is provided. The method includes receiving a first channel state information (CSI)-reference signal (RS) from a base station at first time, applying a matrix for feature extraction to a first eigenvector value according to the first CSI-RS to perform the feature extraction, performing encoding for artificial intelligence (AI)-based CSI compression, based on a value according to the feature extraction, and transmitting feedback according to the AI-based CSI compression to the base station.

### CROSS-REFERENCE TO RELATED APPLICATION(S)

This application is based on and claims priority under 35 U.S.C. § 119 (a) of a Korean patent application number 10-2024-0185587, filed on Dec. 13, 2024, in the Korean Intellectual Property Office, the disclosure of which is incorporated by reference herein in its entirety.

### BACKGROUND

### 1. Field

The disclosure relates to wireless communication systems. More particularly, the disclosure relates to a method and an apparatus for performing compression of channel state information (CSI) based on an enhanced artificial intelligence (AI) model by extracting eigenvector features in a wireless communication system.

### 2. Description of Related Art

Considering the development of wireless communication from generation to generation, the technologies have been developed mainly for services targeting humans, such as voice calls, multimedia services, and data services. Following the commercialization of 5th generation (5G) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6^{th} generation (6G) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3 THz bands). It is expected that, due to severer path loss and atmospheric absorption in the terahertz bands than those in millimeter wave (mmWave) bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple-input multiple-output (MIMO), full dimensional MIMO (FD-MIMO), array antennas, and multiantenna transmission technologies, such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems, a full-duplex technology for enabling an uplink transmission and a downlink transmission to simultaneously use the same frequency resource at the same time, a network technology for utilizing satellites, high-altitude platform stations (HAPS), and the like in an integrated manner, an improved network structure for supporting mobile base stations and the like and enabling network operation optimization and automation and the like, a dynamic spectrum sharing technology via collision avoidance based on a prediction of spectrum usage, an use of artificial intelligence (AI) in wireless communication for improvement of overall network operation by utilizing AI from a designing phase for developing 6G and internalizing end-to-end AI support functions, and a next-generation distributed computing technology for overcoming the limit of user equipment (UE) computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services, such as truly immersive extended reality (XR), high-fidelity mobile hologram, and digital replica could be provided through 6G communication systems. In addition, services, such as remote surgery for security and reliability enhancement, industrial automation, and emergency response will be provided through the 6G communication system such that the technologies could be applied in various fields, such as industry, medical care, automobiles, and home appliances.

In a wireless communication system, channel state information (CSI) may be used to estimate the state of a channel between a UE and a base station. In this case, an artificial intelligence (AI) model may be used to reduce the overhead of a reference signal for CSI estimation and to report the CSI more effectively. Accordingly, a method is being considered to extract features of an eigenvector of the channel and report the CSI through CSI compression based on an improved AI model.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an apparatus for compressing and reconstructing AI-based CSI in wireless communication systems.

Another aspect of the disclosure is to provide procedures for CSI compression and reconstruction based on an improved AI model by extracting features of the eigenvector of the channel.

Additional aspects will be set forth in part in the description which follows and, in part, will be apparent from the description, or may be learned by practice of the presented embodiments.

In accordance with an aspect of the disclosure, a method performed by user equipment (UE) in a wireless communication system is provided. The method includes receiving a first channel state information (CSI)-reference signal (RS) from a base station at first time, applying a matrix for feature extraction to a first eigenvector value according to the first CSI-RS to perform the feature extraction, performing encoding for artificial intelligence (AI)-based CSI compression, based on a value according to the feature extraction, and transmitting feedback according to the AI-based CSI compression to the base station.

In accordance with another aspect of the disclosure, a method performed by a base station in a wireless communication system is provided. The method includes transmitting a first channel state information (CSI)-reference signal (RS) to user equipment (UE) at first time, receiving, from the UE, first feedback in which encoding for artificial intelligence (AI)-based CSI compression is performed based on a value obtained by applying a matrix for feature extraction to an eigenvector value according to the first CSI-RS, performing decoding for AI-based CSI reconstruction, based on the first feedback, and applying an inverse matrix of the matrix for feature extraction to the decoded feedback value.

In accordance with another aspect of the disclosure, a user equipment (UE) in a wireless communication system is provided. The UE includes a transceiver, and a controller coupled to the transceiver, and the controller may be configured to receive a first channel state information (CSI)-reference signal (RS) from a base station at first time, apply a matrix for feature extraction to a first eigenvector value according to the first CSI-RS to perform the feature extraction, perform encoding for artificial intelligence (AI)-based CSI compression, based on a value according to the feature extraction, and transmit feedback according to the AI-based CSI compression to the base station.

In accordance with another aspect of the disclosure, a base station in a wireless communication system is provided. The base station includes a transceiver, and a controller coupled to the transceiver, and the controller may be configured to transmit a first channel state information (CSI)-reference signal (RS) to user equipment (UE) at first time, receive, from the UE, first feedback in which encoding for AI-based CSI compression is performed based on a value obtained by applying a matrix for feature extraction to an eigenvector value according to the first CSI-RS, perform decoding for artificial intelligence (AI)-based CSI reconstruction, based on the first feedback, and apply an inverse matrix of the matrix for feature extraction to the decoded feedback value.

Various embodiments of the disclosure provide a device and a method capable of effectively providing services in a wireless communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication environment according to an embodiment of the disclosure;

FIG. 2 illustrates a configuration of a base station in a wireless communication system according to an embodiment of the disclosure;

FIG. 3 illustrates a configuration of a UE in a wireless communication system according to an embodiment of the disclosure;

FIG. 4 illustrates a process for reporting channel state information (CSI) using an artificial intelligence (AI) model in a wireless communication system according to an embodiment of the disclosure;

FIG. 5 illustrates a process for performing codebook-based CSI reporting in a wireless communication system according to an embodiment of the disclosure;

FIGS. 6A and 6B illustrate a process for performing CSI compression and reporting using an AI model in a wireless communication system according to various embodiments of the disclosure;

FIG. 7 illustrates a process for performing AI-based CSI compression and reporting based on feature extraction of an eigenvector according to an embodiment of the disclosure;

FIGS. 8A and 8B illustrate a process for performing AI-based CSI compression and reporting based on feature extraction of an eigenvector according to an orthogonal matrix according to various embodiments of the disclosure;

FIGS. 9A and 9B illustrate a process for performing AI-based CSI compression and reporting based on feature extraction of an eigenvector according to a non-orthogonal matrix according to various embodiments of the disclosure

FIGS. 10, 11, and 12 illustrate a process for performing CSI compression and reporting by considering an AI-based time domain based on feature extraction of an eigenvector according to various embodiments of the disclosure;

FIGS. 13 and 14 illustrate a process for performing CSI compression and reporting by considering AI-based channel prediction and a time domain based on feature extraction of an eigenvector according to various embodiments of the disclosure;

FIG. 15 illustrates a signal flow for performing AI-based CSI compression and reporting based on network-side AI model training according to an embodiment of the disclosure;

FIG. 16 illustrates a signal flow for performing AI-based CSI compression and reporting based on AI model training in a UE according to an embodiment of the disclosure;

FIG. 17 illustrates an operation flow of a UE for performing AI-based CSI compression and reporting based on feature extraction of an eigenvector according to an embodiment of the disclosure; and

FIG. 18 illustrates an operation flow of a base station for performing AI-based CSI compression and reporting based on feature extraction of an eigenvector according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, various embodiments of the disclosure will be described based on an approach of hardware. However, various embodiments of the disclosure include a technology that uses both hardware and software, and thus the various embodiments of the disclosure may not exclude the perspective of software.

In the following description, terms referring to device elements (e.g., control unit, processor, artificial intelligence (AI) model, encoder, decoder, autoencoder (AE), and neural network (NN) model), terms referring to data (e.g., signal, feedback, report, reporting, information, parameter, value, bit, and codeword), and the like are illustratively used for the sake of descriptive convenience. Therefore, the disclosure is not limited by the terms as used below, and other terms having equivalent technical meanings may be used.

Furthermore, various embodiments of the disclosure will be described using terms used in some communication standards (e.g., the 3rd generation partnership project (3GPP)), but they are for illustrative purposes only. Various embodiments of the disclosure may be easily applied to other communication systems through modifications.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

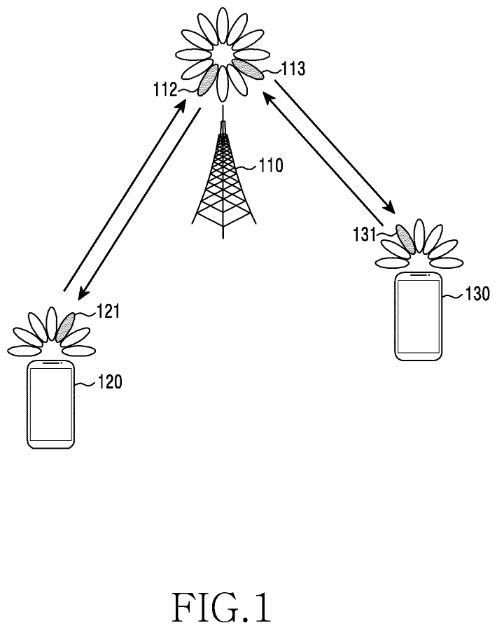

FIG. 1 illustrates a wireless communication system according to an embodiment of the disclosure.

Referring to FIG. 1, it illustrates a base station 110, a UE 120, and a UE 130 as some of the nodes that utilize a wireless channel in a wireless communication system. Although FIG. 1 illustrates only one base station, other base stations identical or similar to the base station 110 may be further included.

The base station 110 is a network infrastructure that provides wireless access to the UEs 120 and 130. The base station 110 has coverage defined as a certain geographical area based on the distance at which it is able to transmit signals. The base station 110 may be referred to as an “access point (AP)”, “eNodeB (eNB)”, “gNodeB (gNB)”, “5^{th} generation node (5G node)”, “6^{th} generation node (6G node)”, “wireless point”, “transmission/reception point (TRP)”, or other terms having equivalent technical meanings, in addition to the base station.

Each of the UE 120 and the UE 130 is a device used by a user and performs communication with the base station 110 through a wireless channel. In some cases, at least one of the UE 120 and the UE 130 may be operated without the user's involvement. For example, at least one of the UE 120 and the UE 130 is a device performing machine-type communication (MTC) and may not be carried by the user. Each of the UE 120 and the UE 130 may be referred to as a “user equipment”, “mobile station”, “subscriber station”, “customer premises equipment (CPE)”, “remote terminal”, “wireless terminal”, “electronic device”, “user device”, or other terms having similar or equivalent technical meanings, in addition to a “terminal”.

The base station 110, the UE 120, and the UE 130 may transmit and receive wireless signals in a millimeter wave (mmWave) band (e.g., 28 GHz, 30 GHz, 38 GHz, 60 GHz, over 60 GHz, or the like). At this time, in order to improve the channel gain, the base station 110, the UE 120, and the UE 130 may perform beamforming. Here, the beamforming may include transmission beamforming and reception beamforming. For example, the base station 110, the UE 120, and the UE 130 may give directionality to the transmission signal or the reception signal. To this end, the base station 110 and the UE 120 and 130 may select serving beams 112, 113, 121, and 131 through a beam search or beam management procedure. After the serving beams 112, 113, 121, and 131 are selected, subsequent communication may be performed through resources that are in a quasi co-located (QCL) relationship with the resources that transmit the serving beams 112, 113, 121, and 131.

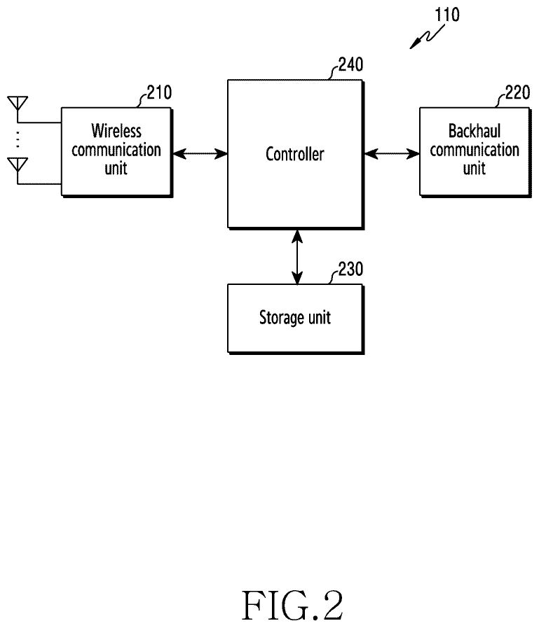

FIG. 2 illustrates a configuration of a base station in a wireless communication system according to an embodiment of the disclosure. According to various embodiments of the disclosure, the base station 110 may be referred to as a network for convenience. The configuration illustrated in FIG. 2 may be understood as a configuration of the base station 110. The terms “unit”, “-er”, or the like, used below may indicate a unit that processes at least one function or operation, and this may be implemented by hardware, software, or a combination of hardware and software.

Referring to FIG. 2, the base station 110 may include a wireless communication unit 210, a backhaul communication unit 220, a storage unit 230, and a controller 240.

The wireless communication unit 210 performs functions for transmitting and receiving signals through a wireless channel. For example, the wireless communication unit 210 performs conversion between a baseband signal and a bit stream according to the physical layer specifications of a system. For example, when transmitting data, the wireless communication unit 210 encodes and modulates a transmission bit stream to generate complex symbols. In addition, when receiving data, the wireless communication unit 210 reconstructs a reception bit stream by demodulating and decoding the baseband signal. In addition, the wireless communication unit 210 up-converts a baseband signal into a radio frequency (RF) band signal and transmits it through an antenna, and down-converts an RF band signal received through the antenna into a baseband signal.

To this end, the wireless communication unit 210 may include a transmitting filter, a receiving filter, an amplifier, a mixer, an oscillator, a digital-to-analog convertor (DAC), an analog-to-digital convertor (ADC), and the like. In addition, the wireless communication unit 210 may include a plurality of transmitting and receiving paths. Furthermore, the wireless communication unit 210 may include at least one antenna array including a plurality of antenna elements. In terms of hardware, the wireless communication unit 210 may be configured as a digital unit and an analog unit, and the analog unit may be configured as a plurality of sub-units depending on operating power, operating frequency, and the like.

The wireless communication unit 210 may transmit and receive signals. To this end, the wireless communication unit 210 may include at least one transceiver. For example, the wireless communication unit 210 may transmit a synchronization signal, a reference signal, system information, a message, control information, or data. In addition, the wireless communication unit 210 may perform beamforming.

The wireless communication unit 210 transmits and receives signals as described above. Accordingly, all or part of the wireless communication unit 210 may be referred to as a “transmitter”, a “receiver”, or a “transceiver”. In addition, in the following description, transmission and reception performed through a wireless channel are used to indicate the processing described above is performed by the wireless communication unit 210.

The backhaul communication unit 220 provides an interface for performing communication with other nodes in the network. For example, the backhaul communication unit 220 converts a bit stream, transmitted from the base station 110 to another node, such as another access node, another base station, an upper node, a core network, or the like, into a physical signal, and converts a physical signal received from another node into a bit stream.

The storage unit 230 stores data, such as a basic program, an application program, and setting information for the operation of the base station 110. The storage unit 230 may include memory. The storage unit 230 may be configured as volatile memory, nonvolatile memory, or a combination of the volatile memory and the nonvolatile memory. In addition, the storage unit 230 provides the stored data according to a request from the controller 240. According to an embodiment of the disclosure, the storage unit 230 may store learning data for AI-based CSI reporting, and may apply the stored learning data to a neural network structure for AI-based CSI reporting.

The controller 240 controls the overall operation of the base station 110. For example, the controller 240 transmits and receives signals through the wireless communication unit 210 or through the backhaul communication unit 220. In addition, the controller 240 records and reads data to and from the storage unit 230. In addition, the controller 240 may perform functions of the protocol stack required for the communication standard. To this end, the controller 240 may include at least one processor. According to various embodiments of the disclosure, the controller 240 may control the base station to perform operations according to various embodiments.

The configuration of the base station 110 illustrated in FIG. 2 is only an example of the base station, and the base station performing various embodiments of the disclosure are not limited to the configuration illustrated in FIG. 2. For example, according to various embodiments of the disclosure, some configurations may be added, deleted, or changed.

Although the base station is described as a single entity in FIG. 2, the disclosure is not limited thereto. The base station according to various embodiments of the disclosure may be implemented to form an access network having a distributed deployment, as well as an integrated deployment. According to an embodiment of the disclosure, the base station may be distinguished into a central unit (CU) and a digital unit (DU), and may be configured such that the CU performs upper layer functions (e.g., radio link control (RLC), packet data convergence protocol (PDCP), and radio resource control (RRC)) and such that the DU performs lower layer functions (e.g., medium access control (MAC) and physical (PHY)). The DU of the base station may form beam coverage on a wireless channel.

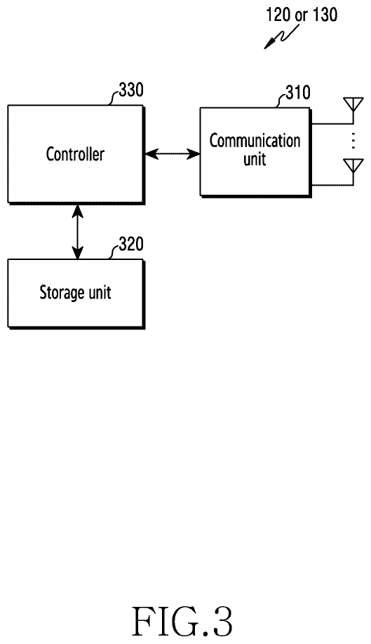

FIG. 3 illustrates a configuration of a UE in a wireless communication system according to an embodiment of the disclosure. The configuration illustrated in FIG. 3 may be understood as the configuration of the UE 120 or 130. The terms “unit”, “-er”, or the like, used below may indicate a unit that processes at least one function or operation, and this may be implemented by hardware, software, or a combination of hardware and software.

Referring to FIG. 3, the UE 120 or 130 may include a communication unit 310, a storage unit 320, and a controller 330.

The communication unit 310 performs functions for transmitting and receiving signals through a wireless channel. For example, the communication unit 310 performs conversion between baseband signals and bit streams depending on the physical layer specifications of a system. For example, when transmitting data, the communication unit 310 encodes and modulates a transmission bit stream to generate complex symbols. In addition, when receiving data, the communication unit 310 reconstructs a reception bit stream by demodulating and decoding the baseband signal. In addition, the communication unit 310 up-converts a baseband signal into a radio frequency (RF) band signal and transmits it through an antenna, and down-converts an RF band signal received through the antenna into a baseband signal. For example, the communication unit 310 may include a transmitting filter, a receiving filter, an amplifier, a mixer, an oscillator, a DAC, an ADC, and the like.

In addition, the communication unit 310 may include a plurality of transmitting and receiving paths. Furthermore, the communication unit 310 may include an antenna unit. The communication unit 310 may include at least one antenna array including a plurality of antenna elements. In terms of hardware, the communication unit 310 may be configured as a digital circuit and an analog circuit (e.g., a radio frequency integrated circuit (RFIC)). Here, the digital circuit and the analog circuit may be implemented as one package. In addition, the communication unit 310 may include a plurality of RF chains. The communication unit 310 may perform beamforming. The communication unit 310 may apply beamforming weights to the signal in order to impart directionality to the signal to be transmitted and received according to the configuration of the controller 330. According to an embodiment of the disclosure, the communication unit 310 may include a radio frequency (RF) block (or RF part). The RF block may include a first RF circuitry related to an antenna and a second RF circuitry related to baseband processing. The first RF circuitry may be referred to as RF-A (antenna). The second RF circuitry may be referred to as RF-B (baseband).

In addition, the communication unit 310 may transmit and receive signals. To this end, the communication unit 310 may include at least one transceiver. The communication unit 310 may receive a downlink signal. The downlink signal may include a synchronization signal (SS), a reference signal (RS) (e.g., a cell-specific reference signal (CRS) or a demodulation (DM)-RS), system information (e.g., MIB, SIB, remaining system information (RMSI), or other system information (OSI)), a configuration message, control information, or downlink data. In addition, the communication unit 310 may transmit an uplink signal. The uplink signal may include a random access-related signal (e.g., a random access preamble (RAP) (or message 1 (Msg1) or message 3 (Msg3)), a reference signal (e.g., a sounding reference signal (SRS) or a DM-RS), or a power headroom report (PHR).

In addition, the communication unit 310 may include different communication modules to process signals of different frequency bands. Furthermore, the communication unit 310 may include multiple communication modules to support multiple different wireless access technologies. For example, the different wireless access technologies may include Bluetooth low energy (BLE), wireless fidelity (Wi-Fi), Wi-Fi gigabyte (WiGig), cellular networks (e.g., long-term evolution (LTE) or new radio (NR)), and the like. In addition, the different frequency bands may include super-high frequency (SHF) (e.g., 2.5 GHz or 5 GHz) bands, millimeter (mm) wave (e.g., 38 GHz, 60 GHz, or the like,) bands, and the like. In addition, the communication unit 310 may utilize the same type of wireless access technology in different frequency bands (e.g., unlicensed bands for licensed assisted access (LAA) or citizens broadband radio service (CBRS) (e.g., 3.5 GHZ)).

The communication unit 310 transmits and receives signals as described above. Accordingly, all or part of the communication unit 310 may be referred to as a “transmitter”, a “receiver”, or a “transceiver”. In addition, in the following description, transmission and reception performed through a wireless channel are used to indicate that the processing described above is performed by the communication unit 310.

The storage unit 320 stores data, such as a basic program, an application program, and setting information for the operation of the UE 120. The storage unit 320 may be configured as volatile memory, nonvolatile memory, or a combination of the volatile memory and the nonvolatile memory. In addition, the storage unit 320 provides the stored data according to the request of the controller 330. According to an embodiment of the disclosure, the storage unit 320 may store learning data for AI-based CSI reporting according to the CSI configuration set by the base station.

The controller 330 controls the overall operations of the UE 120 or 130. For example, the controller 330 transmits and receives signals through the communication unit 310. In addition, the controller 330 records and reads data to or from the storage unit 320. In addition, the controller 330 may perform functions of the protocol stack required for the communication standard. To this end, the controller 330 may include at least one processor. The controller 330 may include at least one processor or microprocessor, or may be a part of a processor. In addition, a part of the communication unit 310 and the controller 330 may be referred to as a cellular processor (CP). The controller 330 may include various modules for performing communication. According to various embodiments of the disclosure, the controller 330 may control the UE to perform operations according to various embodiments.

According to various embodiments of the disclosure, an AI model that has learned based on a neural network may be operated through the controller 330 and the storage unit 320. At this time, the controller 330 may be configured as one or more processors. One or more processors may include the functions of a general-purpose processor, such as a CPU, an application processor (AP), or a digital signal processor (DSP), a processor dedicated for graphics, such as a graphics processing unit (GPU) or a vision processing unit (VPU), or an artificial intelligence processor, such as an NPU. One or more processors may be controlled to process input data according to a predefined operation rule or an artificial intelligence model stored in the storage unit 320. Alternatively, if one or more processors are artificial intelligence processors, the artificial intelligence processor may be designed as a hardware structure specialized for processing a specific artificial intelligence model. The artificial intelligence processor may be configured as a separate configuration, instead of being included in the controller 330.

According to an embodiment of the disclosure, the predefined operation rule or artificial intelligence model is characterized by being produced through learning. Here, being produced through learning indicates that a basic artificial intelligence model learns a plurality of pieces of learning data according to a learning algorithm, thereby producing a predefined operation rule or artificial intelligence model configured to perform a desired feature (or purpose). This learning may be performed in the device itself where the artificial intelligence according to the disclosure is executed, or may be performed through a separate server and/or system. Examples of learning algorithms include supervised learning, unsupervised learning, semi-supervised learning, or reinforcement learning, but are not limited thereto. The controller 330 may learn, through a learning algorithm, occurring events, judgments, or information that is collected or input. The controller 330 may store the learning results in the storage unit 320 (e.g., memory).

The artificial intelligence model (AI model) may be configured as multiple neural network layers. The respective neural network layers may have multiple weight values, and may perform neural network operations through operations between the operation results of the previous layer and the multiple weight values. The multiple weight values that the multiple neural network layers have may be optimized by the learning results of the artificial intelligence model. For example, multiple weight values may be updated so that a loss value or cost value obtained from the artificial intelligence model during the learning process is reduced or minimized. The artificial neural network may include a deep neural network (DNN), and may include, for example, a convolutional neural network (CNN), a recurrent neural network (RNN), a restricted Boltzmann machine (RBM), a deep belief network (DBN), a bidirectional recurrent deep neural network (BRDNN), a transformer, long short term memory (LSTM), or deep Q-Networks, but is not limited thereto.

In an embodiment of the disclosure, the controller 330 may execute an algorithm for performing an operation related to artificial intelligence (AI)-based channel state information (CSI) reporting or feedback. In an embodiment of the disclosure, the learned AI model for performing an operation related to AI-based CSI feedback may be configured as hardware, included as software, or configured as a combination of hardware and software in the controller 330. In other words, the controller 330 may include an AI-based CSI feedback controller. The AI-based CSI feedback controller may perform prediction for AI-based channels, identification of prediction performance for each channel, determination on whether to report an identified result, and determination on whether to use AI-based CSI feedback. In addition, according to various embodiments of the disclosure, the controller 330 may include an update unit. The update unit may obtain data (e.g., data related to CSI feedback between the UE and the base station) updated through a learning procedure between the UE and the base station and, based on the data, reconfigure values of parameters (e.g., neural network structure, node layer information, and weight information between nodes) that constitute the neural network. The AI-based CSI feedback controller and the update unit may be, as a set of instructions or codes stored in the storage unit 320, instructions/codes that at least temporarily reside in the controller 330, a storage space storing the instructions/codes, or a part of the circuitry that constitutes the controller 330. According to various embodiments of the disclosure, the controller 330 may control the UEs 120 and 130 to perform operations according to various embodiments.

The configuration of the UE 120 or 130 illustrated in FIG. 3 is only an example of the UE, and the UE performing various embodiments of the disclosure are not limited to the configuration illustrated in FIG. 3. For example, some configurations may be added, deleted, or changed according to various embodiments.

Hereinafter, for the convenience of description, the disclosure will be described based on the AI model included in the UE 120 or 130. For example, the AI model including a specific neural network structure and having learned according to a specific algorithm may be included in the UE 120 or 130. However, the disclosure is not limited thereto, and it may also be applied to the AI model included in the base station 110.

In order to satisfy services in line with the development of wireless communication, an environment is required to support beam management or various frequency bands. In this situation, since there may be various channel environments depending on frequency bands or beams, the consumption of resources for channel estimation and reporting of the UE may increase. To this end, a technology is emerging in relation to AI-based CSI compression that compresses and reports CSI. The channel state reconstructed based on a CSI report according to the existing 5G NR codebook method is reported as a quantized quantity of the codebook, which may cause information loss in the process of transmitting the estimated channel H. To address this issue, a method of configuring more diverse codebooks may be considered, but this may require more data transmission. For this reason, a technology related to AI-based CSI feedback that transmits feedback through AI-based CSI compression, instead of the current 5G NR codebook-based channel feedback, may be considered.

The technology related to AI-based CSI feedback may include a step of learning and configuring based on a specific algorithm to apply CSI feedback to a specific AI model, a step of collecting learning data required for a specific AI model to learn, and a step of verifying the performance of the learned specific AI model. In particular, the disclosure may further include an operation in which the UE detects a channel change, based on the AI model, and compresses and reports it, thereby performing CSI feedback through an optimal AI model.

In explaining the AI model-based CSI reporting method of the disclosure, the AI model will be explained using an auto-encoder (AE) by way of example for convenience. However, the disclosure is not limited to this, and it is applicable to all AI models capable of CSI compression when performing CSI reporting. Here, the auto-encoder may indicate an AI model that includes a bottleneck structure with the same input and output structure. The auto-encoder may compress the CSI measured by the UE into a low-dimensional vector. In other words, the UE may produce compressed CSI through an encoder of the auto-encoder using the measured full CSI or changes in CSI and transmit the compressed CSI to the base station. Accordingly, the base station may receive explicit CSI feedback rather than implicit CSI feedback. The auto-encoder may have advantages in relation to reporting through the CSI compression method. For example, the auto-encoder may accurately evaluate the AI model even when inferring the performance of the AI model because the auto-encoder is aware of ground truth of the original data. For example, since an input value of the auto-encoder is obtained, the performance of the auto-encoder may be measured by comparing an output value of the auto-encoder with the input value. In the case of an auto-encoder that is aware of the ground truth of the original data, it is possible to accurately predict an output value depending on a value input to the auto-encoder. In addition, since the auto-encoder is highly data dependent, the auto-encoder may also be used for anomaly detection that detects unlearned data. According to various embodiments of the disclosure, the UE or the base station may include a separate unit for extracting features of eigenvectors in addition to the auto-encoder (e.g., the encoder of the UE and the decoder of the base station) for the measured CSI. However, this is only an example, and the UE, not limited thereto, may perform feature extraction of eigenvectors, based on CSI, and compression (or encoding) thereof through a single encoder. In addition, the base station may perform reconstruction (or decoding) of CSI and extraction of eigenvectors by applying an inverse matrix to the reconstructed result through a single decoder. According to various embodiments of the disclosure, as described above, the AI model may include an encoder or decoder for performing CSI compression. In addition, the UE 120 or 130 or the base station 110 may further include an encoder for performing feature extraction of an eigenvector or a decoder for obtaining an eigenvector based on feature extraction, in addition to (or including) the encoder/decoder for the CSI compression.

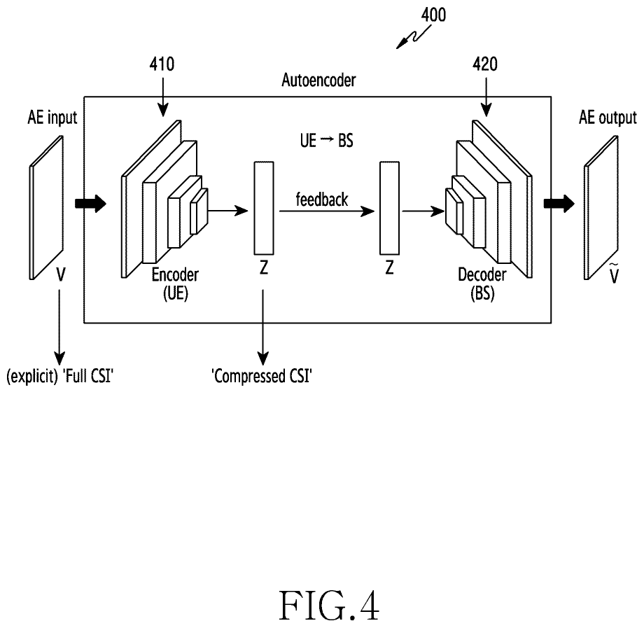

FIG. 4 illustrates a process for reporting channel state information (CSI) using an artificial intelligence (AI) model in a wireless communication system according to an embodiment of the disclosure. Although an auto-encoder will be described as an AI model for reporting CSI (or CIS feedback) by way of example in FIG. 4, the disclosure is not limited thereto. Here, it is assumed that the auto-encoder for reporting CSI is an AI model that has been trained to report CSI, based on a specific learning algorithm.

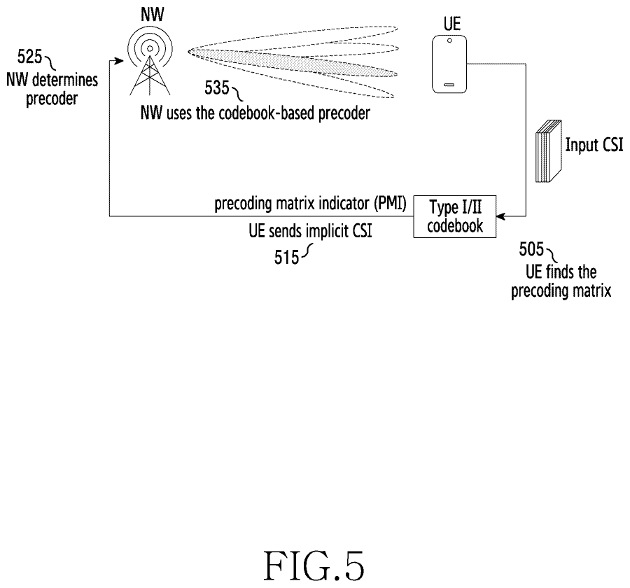

Referring to FIG. 4, an auto-encoder 400 may be a learned AI model for CSI reporting or feedback between the UE and the base station. The UE may produce CSI by pre-processing information about an estimated channel, based on a result of measuring a signal received from the base station. For example, the pre-processing may include eigen value decomposition (EVD) or singular value decomposition (SVD). Here, the produced CSI may indicate full CSI. The full CSI may be input to an encoder 410 of the UE, which is the input of the auto-encoder 400, so that compressed CSI may be produced according thereto. The UE may transmit the compressed CSI to the base station, and the base station may reconstruct the compressed CSI through a decoder 420. At this time, the decoder 420 of the base station may be the output of the auto-encoder 400. According to the above, the auto-encoder 400 may learn CSI compression that may be used for CSI feedback between the UE and the base station. The auto-encoder 400 may perform explicit CSI feedback rather than implicit CSI feedback (as in operation 515 of FIG. 5) through feedback according to the learned CSI compression method. The CSI compression method may require stable performance and high accuracy of the auto-encoder 400. Therefore, according to various embodiments described below, the UE may perform additional pre-processing on a vector for CSI compression to improve the performance of the auto-encoder 400. Based on the above, according to various embodiments of the disclosure, an operation for more efficiently performing CSI reporting based on an AI model will be described. Hereinafter, the CSI disclosed for this purpose may indicate at least one piece of full CSI or compressed CSI.

FIG. 5 illustrates a process for performing codebook-based CSI reporting in a wireless communication system according to an embodiment of the disclosure. More specifically, FIG. 5 illustrates an example of a process for performing legacy CSI reporting.

First, a general technology for existing CSI reporting will be described. In order for the base station to recognize the downlink channel estimated by the UE, the UE may perform a feedback process for transmitting channel information to the base station. Specifically, the base station may transmit a CSI-RS to the UE, and the UE may perform channel estimation, based on the received CSI-RS, to obtain an estimated channel Ĥ. In operation 505, the UE, in order to transmit a precoding matrix indicator (PMI) that is channel information related to a precoding matrix to be used by the base station, may perform decomposition (e.g., EVD, SVD, or the like,) of Ĥ^{H}Ĥ and then identify an eigenvector V according to Ĥ^{H}Ĥ=VΛV^{H}. When transmitting V, the UE may transmit the index of a codebook most similar to V in the form of a PMI, based on a pre-defined codebook disclosed in 3GPP technical specification (TS) 38.214. According to various embodiments of the disclosure, the PMI is described below only as an example because it is information that requires a lot of information or bits among various information for CSI reporting, and the description related to the PMI is not limited thereto, and it is obvious that it may include various feedbacks (e.g., rang indicator (RI), channel quality indicator (CQI), or the like,) included in the CSI report.

Wireless communication technology has been developed in various ways to provide faster data rates, improved coverage, and more stable connections, and in particular, multiple-input multiple-output (MIMO) technology may be used to obtain performance gains by increasing the number of antennas for transmission and reception in relation to physical layers. Accordingly, the 5G new-radio (NR) system supports up to 32 antenna ports, and the future 6G system is intended for the commercialization of extreme massive MIMO (X-MIMO) technology and transmission of up to 256 ports in new frequency bands (e.g., FR3 (10 GHz to 13 GHZ)). For these reasons, an increased number of CSI-RS ports may be required for channel estimation. In the NR system, since the UE feeds back the CSI for the channel estimated from respective CSI-RSs to the base station, the number of CSI-RS ports may increase, which may result in higher CSI feedback overhead. The disclosure proposes a method to address this increased overhead for CSI reporting.

Referring to FIG. 5, a process for codebook-based CSI feedback in a wireless communication system is illustrated. In operation 510, the UE may estimate a suitable channel, based on a CSI-RS received from the base station. In operation 520, the UE may configure a PMI, based on a codebook (e.g., Type I/Type II codebook) and the estimated channel, and report the same to the base station. The base station may determine a precoder according to the PMI (e.g., CSI report) received from the UE in operation 525, and may determine a beam for transmission and reception with respect to the UE using the codebook-based precoder in operation 535. At this time, since the overhead due to PMI transmission increases in proportion to the number of CSI-RS ports as described above, the overhead may significantly increase to support a larger number of ports.

The disclosure proposes various methods to address the issues that may be caused by the existing CSI reporting method as described above, which will be described below.

As described above, more accurate CSI information is required to be transmitted for the use of MIMO, and in addition to 3GPP Type1 and Type2, the Rel-16 Type2 (eType2) codebook has been introduced for compressing channels in the spatial and frequency domains. Unlike the existing Type2 codebook that compresses and feeds back channel information in the spatial domain, the eType2 codebook performs frequency domain compression using channel sparsity in the frequency domain, and enables more precise channel information feedback than the Type2 codebook by using the reduced feedback bits for phase and amplitude information feedback in further subdivided sub-band domains.

However, transmission of V based on such a codebook may cause differences from the actual V due to the limited granularity of the codebook (e.g., limited discrete Fourier transform (DFT), number of beams, amplitude and phase information, or the like), which may result in performance degradation of the MIMO system. In addition, since the influence of the feedback CSI from each UE on the performance improvement of the MU-MIMO system increases further, more accurate CSI feedback is required in future communication systems. To this end, a method of increasing the number of bits used for CSI reporting may be considered in the existing CSI feedback system, but this method may also cause an overhead that increases further as the number of antennas, bandwidth, and granularity of the base station increase. To address this issue, AI/ML-based CSI compression is discussed, in which the UE transmits a low-dimensional vector z (e.g., latent vector) resulting from compressing V itself to the base station, and the base station reconstructs the original V from the compressed vector z.

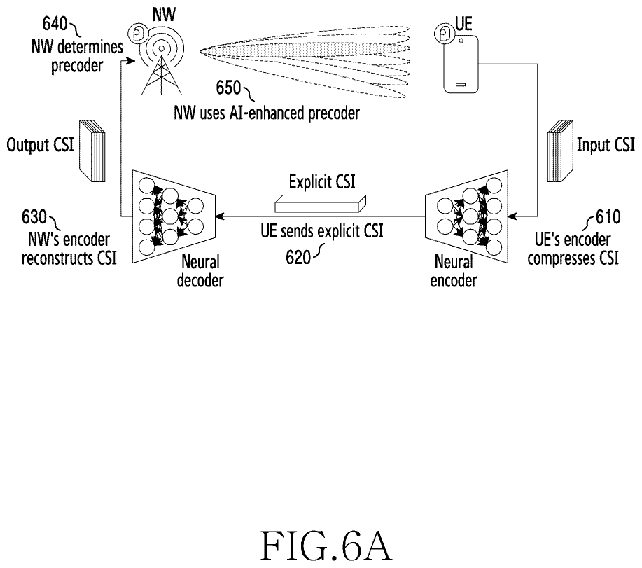

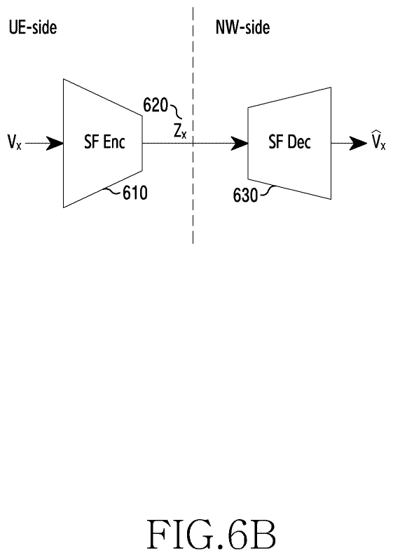

FIGS. 6A and 6B illustrate a process for performing CSI compression and reporting using an AI model in a wireless communication system according to various embodiments of the disclosure.

Referring to FIG. 6A, an AI-based CSI compression technique is illustrated to reduce the overhead of CSI feedback. For CSI compression, the UE and the base station may use an auto-encoder structure including an encoder and a decoder.

In operation 610, the UE may compress input CSI (e.g., an eigenvector of a channel) obtained based on a CSI-RS using an encoder. In operation 620, the UE may transmit the vector (e.g., explicit CSI) compressed by the encoder to the base station. In operation 630, the base station may use the compressed vector as an input to the decoder and reconstruct the CSI using the decoder. In operation 640, the base station may determine a precoder according to the reconstructed CSI from the UE, and in operation 650, the base station may determine a beam for transmission and reception using the AI-based precoder. Here, the eigenvector may indicate a vector that is not a zero vector among vectors whose values obtained by being multiplied by a square matrix become a constant multiple of the eigenvector. For example, the eigenvector may indicate a direction vector whose direction is maintained but whose scale only changes after linear transformation, and the eigen value may indicate the degree of change in the eigenvector.

Hereinafter, the CSI compression process described above will be described with reference to FIG. 6B. As described above, the AI/ML-based CSI compression technology may include a process of compressing channel information in the spatial and frequency domains and feeding it back to the base station. For example, the UE may measure the channel, based on the CSI-RS reception information, and extract an eigenvector matrix required to be used as a precoder of the base station. Thereafter, the UE may compress the eigenvector for each frequency sub-band into a latent vector using an AI encoder model 610, and then feed the corresponding information back to the base station through a CSI report 620. The base station receiving the latent vector included in the CSI report may reconstruct the channel information using an AI decoder model 630.

According to an embodiment of the disclosure, an OFDM-based MIMO system including Nₜ transmission antennas and Nᵣ reception antennas may be considered. In this case, when the symbol xₙ of the n^{th} subcarrier is transmitted, the reception signal may be yₙ=HₙPₙxₙ=zₙ, where Hₙ∈ [symbol] ^{N}^{ᵣ}^{×N}^{ₜ} is a spatial channel matrix, Pₙ is a precoding vector, and zₙ may be a Gaussian noise vector.

At this time, in order to obtain the maximum precoding gain, Pₙ needs to be aligned with the direction of Hₙ. To this end, vₙ, which is an eigenvector of Hₙ, may be used, and the UE needs to report vₙ to the base station. In the existing codebook-based CSI feedback, vₙ may be quantized using the discrete Fourier transform (DFT). On the other hand, in the case of an auto-encoder for CSI compression in the spatial frequency domain, the encoder of the UE may compress V=[v⁽¹⁾, . . . , v^{(N}^{ₛ}⁾]^{T}, which is an eigenvector for Ns sub-bands, into a latent vector (e.g., feature vector) z, and the decoder of the base station may reconstruct the original eigenvector \hat{V} from z. Here, the latent vector z may include bit sequence information corresponding to the PMI.

Such AI/ML-based CSI compression technology may directly use the eigenvector matrix of the channel as the input of the encoder. However, if the input of the encoder is transformed in advance into a form that is efficient for the AI model to learn, instead of the eigenvector matrix itself, performance may be expected to be further improved. For example, a method may be considered to process the input eigenvector into a form that is efficient for the AI model to learn or obtain input by passing it through a specific filter to emphasize the features or correlations between respective elements (e.g., space, frequency, or time domain).

For example, general CSI feedback may utilize various feedback sizes even in the form of a codebook of the related art, and the CSI reconstruction performance may vary among the respective feedback sizes. For example, if the feedback size is sufficiently large, the feedback bits may contain sufficient information about the CSI (e.g., about the eigenvector matrix), and thus the degree of compression by the encoder may be smaller than in the case of a small feedback size. For example, the feedback bits with a large feedback size may contain sufficient information about the eigenvector within a sufficient latent space. However, in the case where the UE and the base station operate with small feedback sizes, the primary CSI information must be included only through small feedback bits. In this case, since the performance or role required for the encoder model to perform compression may be significantly increased, a method must be considered to preferentially compress important dominant information. Therefore, in addition to the CSI compression technology described above, if the input information for the AI model is transformed using a further preprocessing technology, the performance may be expected to be further improved. For such performance improvement, various methods for compressing and reporting CSI through further preprocessing according to various embodiments of the disclosure will be described.

Before describing specific methods according to various embodiments of the disclosure, 3GPP Release 19 defines various cases for CSI compression and reconstruction technology based on AI/ML models.

TABLE 1

| | Target CSI | Whether UE uses past | Whether network uses past |
|---|---|---|---|
| Cases | slot(s) | CSI information | CSI information |
| 0 | Present slot | No | No |
| 1 | Present slot | Yes | No |
| 2 | Present slot | Yes | Yes |
| 3 | Future slot(s) | Yes | No |
| 4 | Future slot(s) | Yes | Yes |
| 5 | Present slot | No | Yes |

For example, among the various cases disclosed in Table 1, Case 0 defines a case in which CSI compression and reconstruction are performed in the spatial-frequency (SF) domain. For example, Case 0 may indicate a model in which a UE including an SF encoder and a base station including an SF decoder perform CSI compression and reconstruction. Cases 1 to 5 define sub-use cases in which the temporal domain and prediction are further considered. For example, Case 1 may indicate a model between a UE including a temporal-spatial-frequency (TSF) encoder and a base station including an SF decoder, Case 2 may indicate a model between a UE including a TSF encoder and a base station including a TSF decoder, Case 3 may indicate a model between a UE including a Predict+TSF encoder and a base station including an SF decoder, Case 4 may indicate a model between a UE including a Predict+TSF encoder and a base station including a TSF decoder, and Case 5 may indicate a model between a UE including an SF encoder and a base station including a TSF decoder.

Hereinafter, models and operations for AI-based CSI compression and reconstruction according to various embodiments of the disclosure will be described based on the cases defined in Table 1. However, this is only an embodiment described as an example and the disclosure is not limited thereto. For example, various embodiments may include an operation of a model between a UE including a Predict+TSF encoder and a base station using a Predict+TSF decoder, where the base station also uses a Predict+TSF decoder, when the target CSI slot is a future slot, or a model between a UE including a Predict+SF encoder and a base station including a TSF decoder.

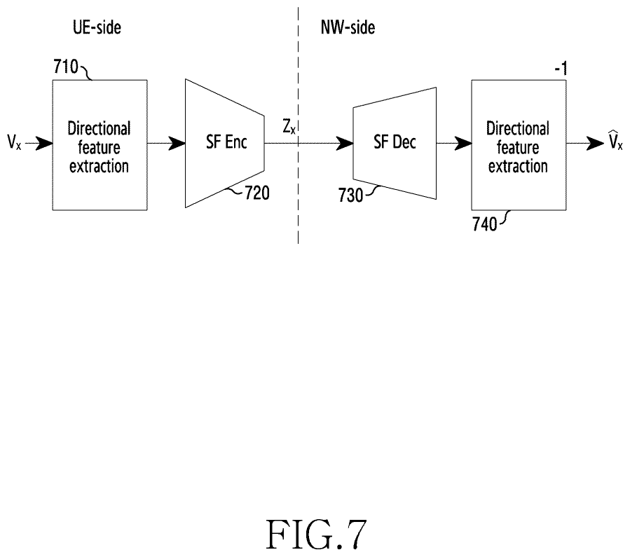

FIG. 7 illustrates a process for performing AI-based CSI compression and reporting based on feature extraction of an eigenvector according to an embodiment of the disclosure. According to various embodiments of the disclosure, FIG. 7 illustrates an auto-encoder including a unit for extracting features, based on eigenvectors, and a unit for extracting eigenvectors after decoding feedback.

Hereinafter, before describing the embodiments of the disclosure, the feature extraction disclosed in FIGS. 7, 8A, 8B, 9A, 9B, and 10 to 18 below indicates an operation of extracting a value for encoding by applying an orthogonal matrix to an eigenvector matrix, and may be performed by separate units in the UE and the base station, or may be performed by an auto-encoder including an encoder and a decoder. In addition, although various embodiments describe directional features that may be considered representatively for improving the performance of the auto-encoder for convenience, this is only an example, and it is obvious to include extraction of various features of channel vectors that may be considered for improving the performance of the AI model. Hereinafter, the operation or unit for the feature extraction of an eigenvector may be referred to as directional feature extraction (DFE) for convenience.

Referring to FIG. 7, a process of performing AI-based compression and reporting according to Case 0 in Table 1 is illustrated. Case 0 is characterized in that the encoder of the UE and the decoder of the base station consider only the current CSI, respectively, without considering the time domain.

In operation 710, the UE may extract features by multiplying the eigenvector (e.g., Vx) of the channel based on the CSI-RS and the DFE matrix. For example, the UE may obtain a value obtained by multiplying the eigenvector and the orthogonal matrix. More specifically, when using the AI-based CSI compression technology, the AI model including the auto-encoder needs to identify correlations between eigenvectors corresponding to the sub-bands (e.g., frequency domain), ranks (e.g., spatial domain), or historical feedbacks (e.g., time domain), respectively. General AI models use eigenvectors without separate transformation as input, but when performing preprocessing to easily transform and extract the comparison of the directionality of the eigenvectors as in operation 710, more efficient learning and improved performance may be expected. According to various embodiments of the disclosure, the preprocessing operation (e.g., using a filter) that highlights the dominant factor of the eigenvector as in operation 710 may include application of a non-orthogonal matrix in addition to application of an orthogonal matrix (e.g., normalized DFT matrix).

In operation 720, the UE may use a value obtained through feature extraction as an input to an encoder according to the AI model. The UE may obtain a compressed latent vector (e.g., Zx) through the encoder and transmit a CSI report including the same to the base station.

In operation 730, the base station may use the latent vector included in the CSI report as an input to a decoder according to the AI model and obtain a value reconstructed through the decoder.

In operation 740, the base station may reconstruct an eigenvector by multiplying the output value of the decoder by the inverse DFE matrix of the DFE matrix. For example, the base station may obtain a reconstructed eigenvector (e.g., \hat{V}ₓ) by multiplying the value reconstructed through the decoder and the inverse matrix of the orthogonal matrix. More specifically, in order to process the eigenvector using the orthogonal matrix, a process of mapping the output value into the form of an eigenvector is required after the operation of the encoder-decoder. Therefore, operation 740 may include a process of multiplying the inverse matrix of the matrix used in operation 710 by the output value of the decoder. According to an embodiment of the disclosure, if the base station directly uses the value to which the orthogonal matrix is applied (e.g., precoding or the like), the process of multiplying the inverse matrix of the orthogonal matrix in operation 740 may be omitted.

Through the above-described steps, various embodiments may expect the effect of improving the model performance and lightening the model in a situation of a small feedback size, and may also improve the model performance and the learning speed of the AI model even in a situation where the time domain is added thereto.

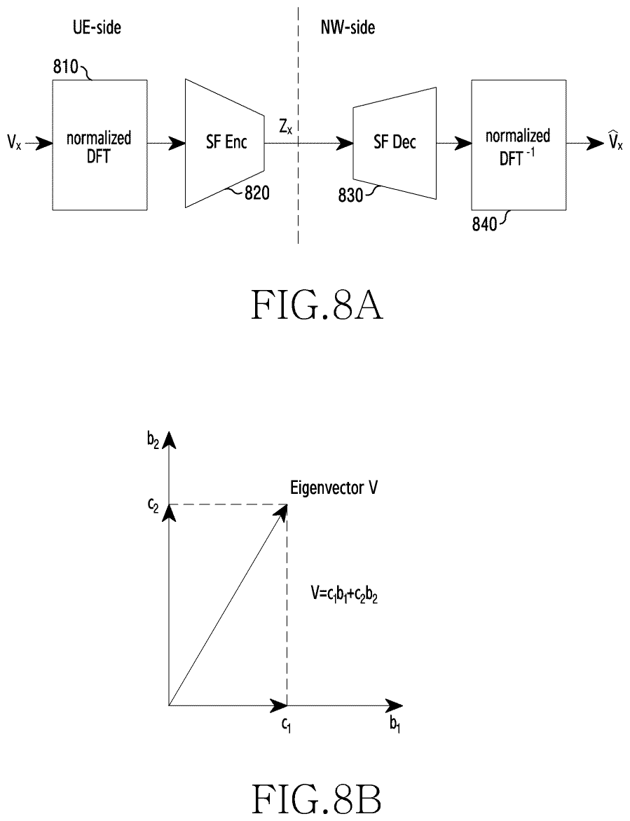

FIGS. 8A and 8B illustrate examples of a process for performing AI-based CSI compression and reporting based on feature extraction of an eigenvector according to an orthogonal matrix according to various embodiments of the disclosure. Various embodiments of the disclosure may apply an orthogonal matrix for extracting features based on eigenvectors and apply an inverse matrix of an orthogonal matrix for extracting eigenvectors after decoding feedback, and an auto-encoder including a DFE process of applying a normalized DFT, which is one of the examples of the orthogonal matrix, is illustrated in FIGS. 8A and 8B.

According to various embodiments of the disclosure, a unitary matrix may be used as the matrix applied to feature extraction of an eigenvector. The unitary matrix may indicate a complex square matrix satisfying U*U=UU*=I, and respective columns of the unitary matrix may be orthogonal to each other. According to an embodiment of the disclosure, an orthogonal matrix, such as a unitary matrix may include a DFT matrix, a normalized DFT matrix, a block diagonal DFT matrix, or the like. The normalized DFT matrix may indicate a matrix whose magnitude is changed based on a DFT matrix so that each column is orthonormal. The block diagonal DFT matrix may indicate a matrix in which DFT matrices are configured on a diagonal depending on the number of two-ports and in which zero matrices are configured on the remaining diagonals.

Hereinafter, an example of a process in which a normalized DFT matrix, as a unitary matrix, is used as a DFE will be described with reference to FIG. 8A.

Referring to FIGS. 8A and 8B, in operation 810, the UE may extract features by multiplying an eigenvector (e.g., Vₓ) of a channel based on the CSI-RS and a normalized DFT matrix. For example, the UE may obtain a value by multiplying the eigenvector and the orthogonal matrix. More specifically, the UE may multiply the respective eigenvectors of the channel estimated according to the CSI-RS by the same orthogonal matrix (e.g., the normalized DFT matrix), thereby obtaining a unique complex number multiplied by each column. Here, the respective eigenvectors on which feature extraction is performed may respectively include eigenvectors for the different sub-bands (e.g., frequency domain), ranks (e.g., spatial domain), or historical feedbacks (e.g., time domain) to be transmitted through the CSI report.

In an embodiment of the disclosure, for example, by multiplying an eigenvector by an orthogonal matrix, the direction of the eigenvector may be mapped to amplitude+phase (Amp+phase) corresponding to the number of columns of the orthogonal matrix. Accordingly, the UE may extract features (e.g., directional features) that are easy for the AI model to learn by highlighting the dominant coefficient.

Referring to FIG. 8B, an example of highlighting the dominant coefficient according to the multiplication of the above-described eigenvector and orthogonal matrix is illustrated. For example, FIG. 8B illustrates an example of mapping the eigenvector V to the basis (e.g., DFT basis) of the orthogonal matrix. The eigenvector V may be applied (e.g., mapped) to an orthogonal matrix having b₁ and b₂ as bases. For example, the UE may obtain a value, such as v=c₁b₁+c₂b₂ by multiplying the eigenvector and the orthogonal matrix, and may identify the directional feature of the obtained value through the constants c₁ and c₂. The AI model (i.e., an encoder) of the UE may more easily learn and compress the value of the channel state using the dominant feature based on the constant values.

In operation 820, the UE may use the value obtained through feature extraction as an input to the encoder according to the AI model. The UE may obtain a compressed latent vector (e.g., Zₓ) through the encoder and transmit a CSI report including the same to the base station.

In operation 830, the base station may use the latent vector included in the CSI report as an input to the decoder according to the AI model, and may obtain a reconstructed value through the decoder.

In operation 840, the base station may reconstruct the eigenvector by multiplying the output value of the decoder by the inverse matrix of the normalized DFT matrix. For example, the base station may obtain the reconstructed eigenvector (e.g., \hat{V}ₓ) by multiplying the value reconstructed through the decoder by the inverse matrix of the orthogonal matrix. More specifically, in order to reconstruct the decoded feedback value back into eigenvector information, the base station may multiply the output value of the decoder by the inverse matrix of the orthogonal matrix (e.g., the inverse matrix of the normalized DFT matrix), thereby obtaining a reconstructed eigenvector. According to an embodiment of the disclosure, the inverse matrix of the normalized DFT matrix is only an example and is not limited thereto, and if the matrix used by the UE for feature extraction is another orthogonal matrix, such as a block diagonal DFT matrix, the inverse matrix used by the base station for reconstruction may include various inverse matrices corresponding to the respective matrices used by the UE.

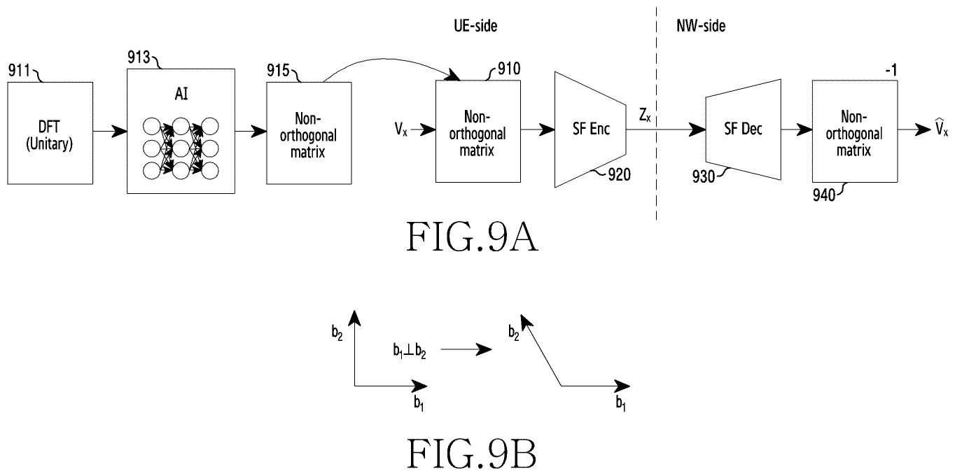

FIGS. 9A and 9B illustrate a process for performing AI-based CSI compression and reporting based on feature extraction of an eigenvector according to a non-orthogonal matrix according to various embodiments of the disclosure. Various embodiments of the disclosure may apply a non-orthogonal matrix for extracting features based on eigenvectors and apply an inverse matrix of a non-orthogonal matrix for extracting eigenvectors after decoding feedback, and an auto-encoder including a process for producing a non-orthogonal matrix using DFT, which is one of examples of orthogonal matrices, is illustrated in FIGS. 9A and 9B.

According to various embodiments of the disclosure, the matrix applied to feature extraction of eigenvectors may be a matrix having non-orthogonal features, as well as a unitary matrix having orthogonal features. For example, FIGS. 9A and 9B illustrate a process for extracting features using a non-orthogonal matrix instead of the normalized DFT in FIGS. 8A and 8B.

For example, a unitary matrix, such as a DFT matrix may express evenly or uniformly the case where all columns are orthogonal and the eigenvectors of the channel are distributed over all spaces. However, in a wireless communication system, the channel may not be uniform among the cells or depending on the surrounding environment, and in particular, may have cell-specific channel features. In order to express such cell-specific channel features, an optimal matrix, instead of an orthogonal matrix with uniform features, may be considered, and the optimal matrix may have non-orthogonal features.

Hereinafter, an example of a process in which a non-orthogonal matrix is used for DFE, including the process of producing the non-orthogonal matrix described above, will be described with reference to FIGS. 9A and 9B.

Referring to FIGS. 9A and 9B, before performing the process of operation 910, the UE may use a unitary matrix (e.g., a DFT matrix) 911 as an initial point to produce a non-orthogonal matrix 915 in the form of a linear combination of respective basis vectors.

According to an embodiment of the disclosure, the DFT matrix used as an initial point for producing a non-orthogonal matrix is only an example and is not limited thereto, and the UE may also use various orthogonal matrices (e.g., unitary matrices including a DFT matrix, a normalized DFT matrix, a block diagonal DFT matrix, and the like) for producing a non-orthogonal matrix.

Referring to FIG. 9B, a unitary matrix having mutually orthogonal basis vectors may be converted into a non-orthogonal matrix in which the bases are not orthogonal through a linear combination. According to an embodiment of the disclosure, although FIG. 9A illustrates a process in which the UE obtains a non-orthogonal matrix using a separate AI model 913 to produce a non-orthogonal matrix, this is only an example, and the process of using an AI model or producing a non-orthogonal matrix separately is not considered an essential step, and the non-orthogonal matrix may be produced through a simple operation process of the UE depending on the channel state, or may be preconfigured in the UE.

According to an embodiment of the disclosure, the non-orthogonal matrix applied by the UE may be a square matrix in which respective columns of the matrix may be non-orthogonal and all columns may be normalized (e.g., norm=1). In addition, since a process of reconstructing the original eigenvector after a linear transformation using the DFE matrix is required, the non-orthogonal matrix needs to have an inverse matrix, and thus, the determinant may be 0.

Referring to FIG. 9A, in operation 910, the UE may extract features by multiplying the eigenvector (e.g., Vₓ) of the channel based on the CSI-RS by a non-orthogonal matrix. For example, the UE may obtain a value by multiplying the eigenvector by the non-orthogonal matrix. More specifically, the UE may multiply the respective eigenvectors of the channel estimated according to the CSI-RS by the same non-orthogonal matrix, thereby obtaining a unique complex number multiplied by each column. Here, the respective eigenvectors on which feature extraction is performed may respectively include eigenvectors for the different sub-bands (e.g., frequency domain), ranks (e.g., spatial domain), or historical feedbacks (e.g., time domain) to be transmitted through the CSI report.

In an embodiment of the disclosure, for example, by multiplying an eigenvector by a non-orthogonal matrix, the direction of the eigenvector may be mapped to amplitude+phase (Amp+phase) corresponding to the number of columns of the non-orthogonal matrix. Accordingly, the UE may extract features (e.g., directional features) that are easy for the AI model to learn by highlighting the dominant coefficient according to the channel features (e.g., cell-specific). For example, Referring to FIG. 9B, the eigenvector V may be mapped to a non-orthogonal basis of the non-orthogonal matrix. The eigenvector V may be applied (e.g., mapped) to a non-orthogonal matrix having non-orthogonal b₁ and b₂ as bases. For example, the UE may obtain a value, such as v=c₁b₁+C₂b₂ by multiplying the eigenvector and the non-orthogonal matrix and identify the directional feature of the obtained value through the constants c₁ and c₂. The AI model (i.e., an encoder) of the UE may more easily learn and compress the value of the channel state using the dominant feature based on the constant values.

In operation 920, the UE may use the value obtained through feature extraction as an input to the encoder according to the AI model. The UE may obtain a compressed latent vector (e.g., Zₓ) through the encoder and transmit a CSI report including the same to the base station.

In operation 930, the base station may use the latent vector included in the CSI report as an input to the decoder according to the AI model, and may obtain a value reconstructed through the decoder.

In operation 940, the base station may reconstruct the eigenvector by multiplying the output value of the decoder by the inverse matrix of the non-orthogonal matrix. For example, the base station may obtain the reconstructed eigenvector (e.g., \hat{V}ₓ) by multiplying the value reconstructed through the decoder by the inverse matrix of the non-orthogonal matrix. More specifically, in order to reconstruct the decoded feedback value back into eigenvector information, the base station may multiply the output value of the decoder by the inverse matrix of the non-orthogonal matrix, thereby obtaining a reconstructed eigenvector.

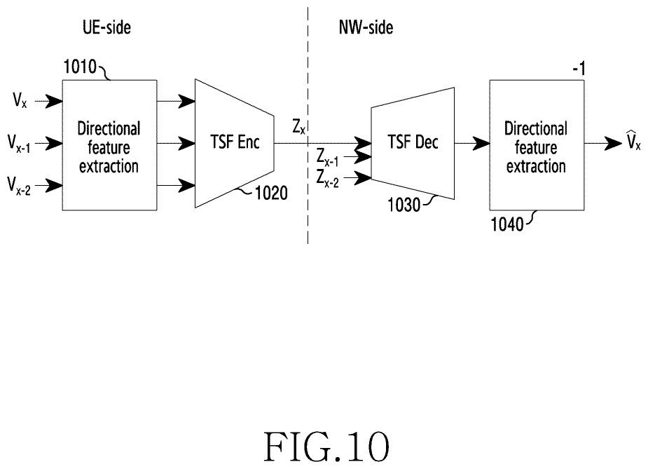

FIGS. 10, 11, and 12 illustrate a process for performing CSI compression and reporting considering an AI-based time domain based on feature extraction of an eigenvector according to various embodiments of the disclosure. More specifically, the redundant description between the processes disclosed in FIGS. 10, 11, and 12 and the processes in FIGS. 7, 8A, 8B, 9A, and 9B may be omitted, and various embodiments may include combinations of the respective steps. For example, the DFE process in FIGS. 10, 11, and 12 may include a process of extracting various features depending on the channel states, in addition to directional features, and the orthogonal matrix described to be applied to feature extraction below may be interpreted as being replaced with the non-orthogonal matrix described in FIGS. 9A and 9B.

According to various embodiments of the disclosure, FIG. 10 illustrates a process of performing AI-based compression and reporting according to Case 2 in Table 1. Case 2 is characterized in that both the encoder of the UE and the decoder of the base station perform the processes of CSI compression, transmission, and reconstruction based on the time domain. For example, the UE in FIG. 10 may include a TSF encoder capable of performing compression based on time, space, and frequency domains, and the base station may include a TSF decoder capable of performing reconstruction based on time, space, and frequency domains.

In operation 1010, the UE may extract features by multiplying an eigenvector (e.g., Vₓ) of the channel based on the CSI-RS by an orthogonal matrix. For example, the UE may obtain a value by multiplying an eigenvector by an orthogonal matrix. According to an embodiment of the disclosure, the UE may also apply the same orthogonal matrix to eigenvectors Vₓ₋₁ and Vₓ₋₂ according to the CSI measured in the past. For example, the UE may obtain values by multiplying the current and past eigenvectors by the orthogonal matrix and use them as inputs to the TSF encoder.

In operation 1020, the UE may use the values obtained through feature extraction as inputs to the encoder according to the AI model. The UE may obtain a compressed latent vector (e.g., Zₓ) through the encoder and transmit a CSI report including the same to the base station. More specifically, through operation 1020, the AI model of the UE may identify a correlation between eigenvectors respectively corresponding to sub-bands (e.g., frequency domain), ranks (e.g., spatial domain), or past feedbacks (e.g., time domain). The AI model of the UE may expect more efficient learning and improved performance when performing processes using the eigenvector features of the past CSI in addition to the eigenvector features of the current CSI. According to various embodiments of the disclosure, the preprocessing operation that highlights the dominant factor of the eigenvectors in operation 1010 may include the application of a non-orthogonal matrix in addition to the application of the orthogonal matrix (e.g., normalized DFT matrix).

In operation 1030, the base station may use the latent vector included in the CSI report as an input to the decoder according to the AI model and obtain a value reconstructed through the decoder. According to an embodiment of the disclosure, the base station may perform decoding by also considering the latent vectors Zₓ₋₁ and Zₓ₋₂ included in the CSI report received in the past. For example, the base station may use the current and past latent vectors as inputs to the TSF decoder.

In operation 1040, the base station may reconstruct the eigenvector by multiplying the output value of the decoder and the inverse DFE matrix of the DFE matrix. For example, the base station may obtain the reconstructed eigenvector (e.g., \hat{V}ₓ) by multiplying the value reconstructed through the decoder by the inverse matrix of the orthogonal matrix. More specifically, in order to process the eigenvector using the orthogonal matrix, a process is required to map the output value into the form of the eigenvector after the operation of the encoder-decoder. Therefore, operation 1040 may include a process of multiplying the output value of the decoder by the inverse matrix of the matrix used in operation 1010. According to an embodiment of the disclosure, if the base station directly uses the value to which the orthogonal matrix is applied (e.g., precoding, or the like), the process of multiplying the inverse matrix of the orthogonal matrix in operation 1040 may be omitted.

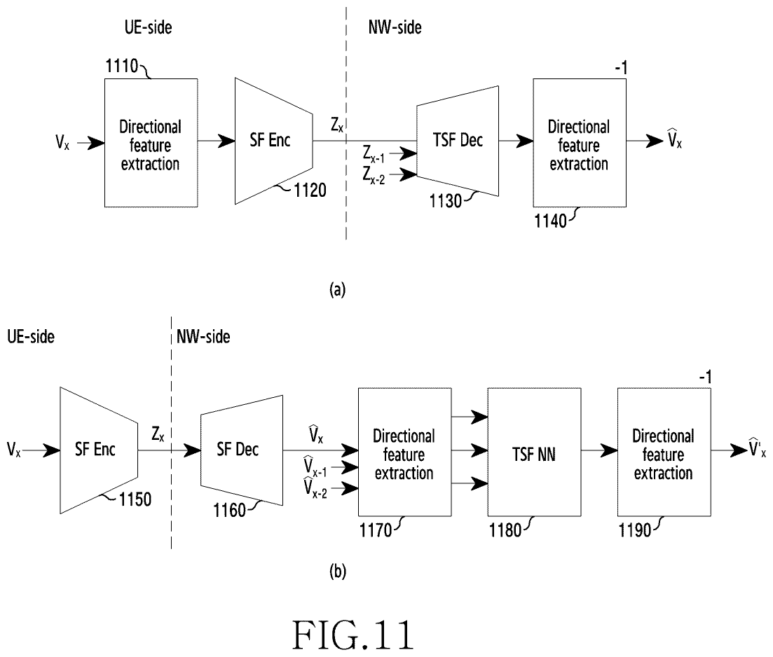

According to various embodiments of the disclosure, FIG. 11 illustrates a process of performing AI-based compression and reporting according to Case 5 in Table 1. Case 5 is characterized in that the UE performs CSI compression without considering the time domain and the base station performs CSI reconstruction based on the time domain. More specifically, the UE in may include an SF encoder capable of performing compression based on the space and frequency domains, and the base station may include a TSF decoder capable of performing reconstruction based on the time, space, and frequency domains in (a) of FIG. 11. The UE may include an SF encoder capable of performing compression based on the space and frequency domains, and the base station may also include an SF encoder, but may further include a TSF neural network (NN) capable of performing CSI reconstruction by further considering the time domain in (b) of FIG. 11.

Referring to (a) of FIG. 11, in operation 1110, the UE may extract features by multiplying an eigenvector (e.g., Vₓ) of the channel based on the CSI-RS and an orthogonal matrix. For example, the UE may obtain a value by multiplying the eigenvector and the orthogonal matrix.

In operation 1120, the UE may use the value obtained through feature extraction as an input to the encoder according to the AI model. The UE may obtain a compressed latent vector (e.g., Zₓ) through the encoder and transmit a CSI report including the same to the base station. According to various embodiments of the disclosure, the preprocessing operation that highlights the dominant factor of the eigenvectors in operation 1110 may include the application of a non-orthogonal matrix in addition to the application of the orthogonal matrix (e.g., normalized DFT matrix).

In operation 1130, the base station may use the latent vector included in the CSI report as an input to the decoder according to the AI model and obtain a value reconstructed through the decoder. According to an embodiment of the disclosure, the base station may perform decoding by also considering the latent vectors Zₓ₋₁ and Zₓ₋₂ included in the CSI report received in the past. For example, the base station may use the current and past latent vectors as inputs to the TSF decoder.

In operation 1140, the base station may reconstruct the eigenvector by multiplying the output value of the decoder and the inverse DFE matrix of the DFE matrix. For example, the base station may obtain the reconstructed eigenvector (e.g., \hat{V}ₓ) by multiplying the value reconstructed through the decoder by the inverse matrix of the orthogonal matrix. More specifically, in order to process the eigenvector using the orthogonal matrix, a process is required to map the output value into the form of the eigenvector after the operation of the encoder-decoder. Therefore, operation 1140 may include a process of multiplying the output value of the decoder by the inverse matrix of the matrix used in operation 1110. According to an embodiment of the disclosure, if the base station directly uses the value to which the orthogonal matrix is applied (e.g., precoding, or the like), the process of multiplying the inverse matrix of the orthogonal matrix in operation 1140 may be omitted.

Referring to (b) of FIG. 11, in operation 1150, the UE may use the value of the eigenvector (e.g., Vₓ) of the channel based on the CSI-RS as an input to the encoder according to the AI model. The UE may obtain a compressed latent vector (e.g., Zₓ) through the encoder and transmit a CSI report including the same to the base station. For example, (b) of FIG. 11 illustrates a case where the process of applying the orthogonal matrix and the inverse matrix for feature extraction is not performed in the UE.

In operation 1160, the base station may use the latent vector included in the CSI report as an input to the decoder according to the AI model and obtain a value reconstructed through the decoder.

In operation 1170, the base station may extract features by multiplying the eigenvector (e.g., \hat{V}ₓ) reconstructed through the decoder and the orthogonal matrix. For example, the base station may obtain a value by multiplying the reconstructed eigenvector by the orthogonal matrix. According to an embodiment of the disclosure, the base station may also apply the same orthogonal matrix to the eigenvectors \hat{V}ₓ₋₁ and \hat{V}ₓ₋₂ according to the CSI reconstructed in the past. For example, the base station may obtain values by respectively multiplying the current and past eigenvectors by the orthogonal matrix and use them as inputs to the TSF NN. More specifically, through operation 1170, the AI model (e.g., TSF NN) of the base station may identify correlations between eigenvectors corresponding to the sub-bands (e.g., frequency domain), ranks (e.g., spatial domain), or historical feedbacks (e.g., time domain), respectively. The AI model of the base station may expect more efficient learning and improved performance when performing processing using the eigenvector features of the past CSI in addition to the eigenvector features of the current CSI. According to various embodiments of the disclosure, the preprocessing operation that highlights the dominant factor of the eigenvector as in operation 1170 may include application of a non-orthogonal matrix in addition to application of an orthogonal matrix (e.g., normalized DFT matrix).

In operation 1180, the base station may produce a value for reconstruction by considering the eigenvector values corresponding to both the current CSI and the past CSI, based on the TSF NN. Here, the TSF NN may indicate a neural network that produces a more accurate current reconstructed CSI by considering the correlation in the time domain of the past reconstructed CSI, which is the output of the decoder.

In operation 1190, the base station may reconstruct the eigenvector by multiplying the output value of the TSF NN and the inverse DFE matrix of the DFE matrix. For example, the base station may obtain the reconstructed eigenvector (e.g., 1x) by multiplying the value reconstructed through the TSF NN by the inverse matrix of the orthogonal matrix. More specifically, in order to process the eigenvector using the orthogonal matrix, a process is required to map the output value into the form of the eigenvector. Therefore, operation 1190 may include a process of multiplying the inverse matrix of the matrix used in operation 1170 by the output value of the TSF NN. According to an embodiment of the disclosure, if the base station directly uses the value to which the orthogonal matrix is applied (e.g., precoding, or the like), the process of multiplying the inverse matrix of the orthogonal matrix in operation 1190 may be omitted.

According to various embodiments of the disclosure, although (b) of FIG. 11 illustrates the case where previously reconstructed CSI is directly used as input for feature extraction (e.g., DFE), the disclosure is not limited thereto, and operation 1170 for feature extraction may be performed before operation 1150, or operation 1190 may be performed between operation 1160 and operation 1180.

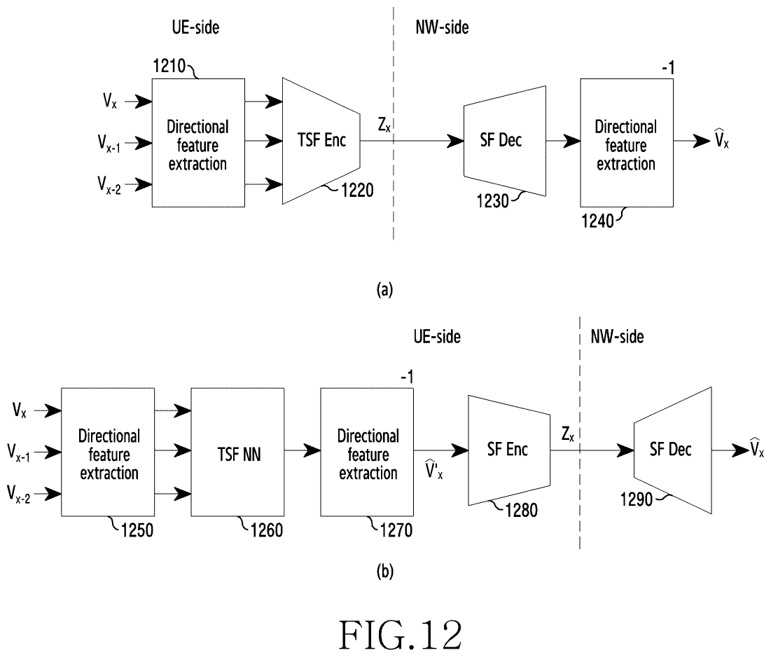

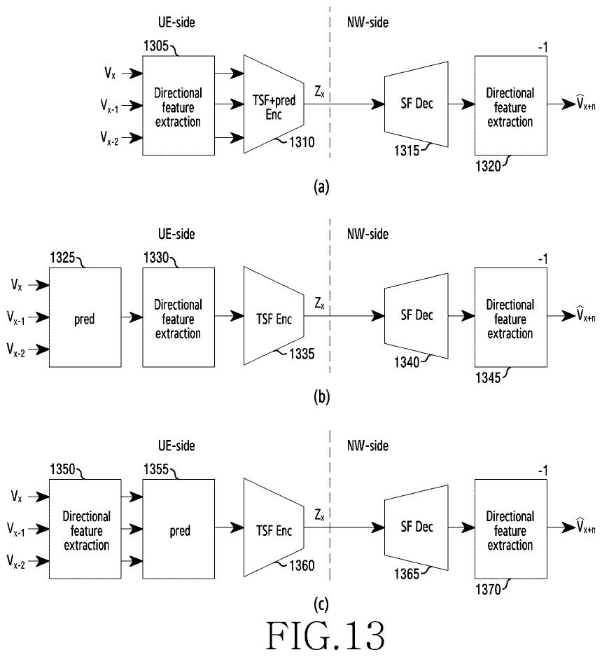

FIG. 12 illustrate a process for performing AI-based compression and reporting according to Case 1 in Table 1. Case 1 is characterized in that the UE performs CSI reconstruction by considering the time domain and the base station performs CSI reconstruction without considering the time domain. More specifically, the UE may include a TSF encoder capable of performing compression based on time, space, and frequency domains, and the base station may include an SF decoder capable of performing reconstruction based on space and frequency domains in (a) of FIG. 12. The UE includes an SF encoder capable of performing compression based on space and frequency domains, but may further include a TSF neural network (NN) capable of performing CSI reconstruction by further considering the time domain, and the base station may include an SF decoder capable of performing reconstruction based on space and frequency domains in (b) of FIG. 12.

Referring to (a) of FIG. 12, in operation 1210, the UE may extract features by multiplying an eigenvector (e.g., Vₓ) of the channel based on the CSI-RS and an orthogonal matrix. For example, the UE may obtain a value by multiplying the eigenvector and the orthogonal matrix. According to an embodiment of the disclosure, the UE may also apply the same orthogonal matrix to eigenvectors Vₓ₋₁ and Vₓ₋₂ according to the CSI measured in the past. For example, the UE may obtain values by multiplying the current and past eigenvectors by the orthogonal matrix and use them as inputs to the TSF encoder.

In operation 1220, the UE may use the values obtained through feature extraction as inputs to the encoder according to the AI model. The UE may obtain a compressed latent vector (e.g., Zₓ) through the encoder and transmit a CSI report including the same to the base station. More specifically, through operation 1220, the AI model of the UE may identify correlations between eigenvectors corresponding to the sub-bands (e.g., frequency domain), ranks (e.g., spatial domain), or historical feedbacks (e.g., time domain), respectively. The AI model of the UE may expect more efficient learning and improved performance when performing processing using the eigenvector features of the past CSI in addition to the eigenvector features of the current CSI. According to various embodiments of the disclosure, the preprocessing operation that highlights the dominant factor of the eigenvector as in operation 1210 may include application of a non-orthogonal matrix in addition to application of an orthogonal matrix (e.g., normalized DFT matrix).

In operation 1230, the base station may use the latent vector included in the CSI report as an input to the decoder according to the AI model and obtain a value reconstructed through the decoder.

In operation 1240, the base station may reconstruct the eigenvector by multiplying the output value of the decoder by the inverse DFE matrix of the DFE matrix. For example, the base station may obtain the reconstructed eigenvector (e.g., \hat{V}ₓ) by multiplying the value reconstructed through the decoder by the inverse matrix of the orthogonal matrix. More specifically, in order to process the eigenvector using the orthogonal matrix, a process is required to map the output value into the form of the eigenvector after the operation of the encoder-decoder. Therefore, operation 1240 may include a process of multiplying the output value of the decoder by the inverse matrix of the matrix used in operation 1210. According to an embodiment of the disclosure, if the base station directly uses the value to which the orthogonal matrix is applied (e.g., precoding, or the like), the process of multiplying the inverse matrix of the orthogonal matrix in operation 1240 may be omitted.

Referring to (b) of FIG. 12, in operation 1250, the UE may extract features by multiplying an eigenvector (e.g., Vₓ) of the channel based on the CSI-RS and an orthogonal matrix. For example, the UE may obtain a value by multiplying the eigenvector and the orthogonal matrix. According to an embodiment of the disclosure, the UE may also apply the same orthogonal matrix to eigenvectors Vₓ₋₁ and Vₓ₋₂ according to the CSI measured in the past. For example, the UE may obtain values by multiplying the current and past eigenvectors by the orthogonal matrix and use them as inputs to the TSF NN. According to various embodiments of the disclosure, the preprocessing operation that highlights the dominant factor of the eigenvector as in operation 1250 may include application of a non-orthogonal matrix in addition to application of an orthogonal matrix (e.g., normalized DFT matrix).

In operation 1260, the UE may produce a value for compression based on the eigenvector values corresponding to both the current CSI and the past CSI, based on the TSF NN. Here, the TSF NN may indicate a neural network that processes the input of the UE encoder to allow the base station to produce more accurate current reconstructed CSI by considering the correlation between the eigenvectors of the past CSI in the time domain.

In operation 1270, the UE may reconstruct the eigenvector by multiplying the output value of the TSF NN by the inverse DFE matrix of the DFE matrix. For example, the UE may obtain a reconstructed eigenvector (e.g., 2) by multiplying the value reconstructed through the TSF NN by the inverse matrix of the orthogonal matrix. More specifically, in order to process the eigenvector using the orthogonal matrix, a process is required to map the output value into the form of an eigenvector. Therefore, operation 1270 may include a process of multiplying the inverse matrix of the matrix used in operation 1250 by the output value of the TSF NN. According to an embodiment of the disclosure, if the base station directly uses the value to which the orthogonal matrix is applied (e.g., precoding, or the like), the process of multiplying the inverse matrix of the orthogonal matrix in operation 1270 may be omitted.

In operation 1280, the UE may use the reconstructed eigenvector value (e.g., \hat{V}ₓ) as an input to the encoder according to the AI model. The UE may obtain a compressed latent vector (e.g., Zₓ) through the encoder and transmit a CSI report including the same to the base station.

In operation 1290, the base station may use the latent vector included in the CSI report as an input to the decoder according to the AI model and obtain an eigenvector (e.g., \hat{V}ₓ) reconstructed through the decoder.

According to various embodiments of the disclosure, although (b) of FIG. 12 illustrates the case where the eigenvectors reconstructed through preprocessing are directly used as inputs to the encoder, the disclosure is not limited thereto, and operation 1250 for feature extraction may be performed after operation 1260 for the TSF NN, or operation 1270 may be performed after operation 1290.

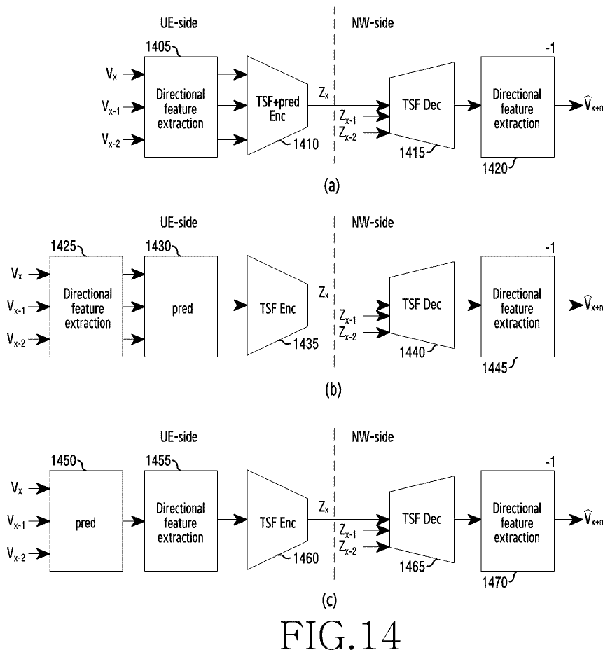

FIGS. 13 and 14 illustrate a process for performing CSI compression and reporting by considering AI-based channel prediction and a time domain based on feature extraction of an eigenvector according to various embodiments of the disclosure. More specifically, the redundant description between the processes disclosed in FIGS. 13 and 14 and the processes in FIGS. 7, 8A, 8B, 9A and 9B may be omitted, and various embodiments may include combinations of the respective steps. For example, the DFE process in FIGS. 13 and 14 may include a process of extracting various features depending on the channel states, in addition to directional features, and the orthogonal matrix described to be applied to feature extraction below may be interpreted as being replaced with the non-orthogonal matrix described in FIGS. 9A and 9B.

According to various embodiments of the disclosure, FIG. 13 illustrates a process of performing AI-based compression and reporting according to Case 3 in Table 1. Case 3 is characterized in that an encoder of the UE performs a process of channel prediction and a process of CSI compression and transmission by considering the time domain. For example, the UE in FIG. 13 may include a TSF encoder (e.g., Predict+TSF encoder) capable of performing compression, based on time, space, and frequency domains, including future channel prediction, and the base station may include an SF decoder capable of performing reconstruction based on space and frequency domains.

Referring to (a) of FIG. 13, in operation 1305, the UE may extract features by multiplying an eigenvector (e.g., Vₓ) of the channel based on the CSI-RS by an orthogonal matrix. For example, the UE may obtain a value by multiplying the eigenvector by the orthogonal matrix. According to an embodiment of the disclosure, the UE may also apply the same orthogonal matrix to the eigenvectors Vₓ₋₁ and Vₓ₋₂ according to the CSI measured in the past. For example, the UE may obtain values by multiplying the current and past eigenvectors by the orthogonal matrix and use them as inputs to the TSF encoder.

In operation 1310, the UE may use the values obtained through feature extraction as inputs to the encoder according to the AI model. The UE may obtain a compressed latent vector (e.g., Zₓ) through the encoder and transmit a CSI report including the same to the base station. More specifically, through operation 1310, the AI model of the UE may identify correlations between eigenvectors corresponding to the sub-bands (e.g., frequency domain), ranks (e.g., spatial domain), or historical feedbacks (e.g., time domain), respectively. The AI model of the UE may expect more efficient learning and improved performance when performing processing using the eigenvector features of the past CSI in addition to the eigenvector features of the current CSI. According to various embodiments of the disclosure, the preprocessing operation that highlights the dominant factor of the eigenvector as in operation 1305 may include application of a non-orthogonal matrix in addition to application of an orthogonal matrix (e.g., normalized DFT matrix).

According to an embodiment of the disclosure, in operation 1310, the UE may predict a value of the channel at future time (x+n), in addition to a value of the channel at the current time (x), through the encoder. For example, the encoder of the UE may predict the values of the channel corresponding to one or more consecutive time from x to x+n, based on the obtained values, and the latent vector may be compressed and produced by further considering such predicted values. Here, the Predic+TSF encoder may indicate a neural network that performs both compression and prediction of the CSI.

In operation 1315, the base station may use the latent vector included in the CSI report as an input to the decoder according to the AI model and obtain a value reconstructed through the decoder.

In operation 1320, the base station may reconstruct the eigenvector by multiplying the output value of the decoder and the inverse DFE matrix of the DFE matrix. For example, the base station may obtain the reconstructed eigenvector (e.g., \hat{V}ₓ) by multiplying the value reconstructed through the decoder by the inverse matrix of the orthogonal matrix. More specifically, in order to process the eigenvector using the orthogonal matrix, a process is required to map the output value into the form of the eigenvector after the operation of the encoder-decoder. Therefore, operation 1320 may include a process of multiplying the output value of the decoder by the inverse matrix of the matrix used in operation 1305. According to an embodiment of the disclosure, if the base station directly uses the value to which the orthogonal matrix is applied (e.g., precoding, or the like), the process of multiplying the inverse matrix of the orthogonal matrix in operation 1320 may be omitted. Here, the reconstructed eigenvector may include the reconstructed eigenvector \hat{V}ₓ₊ₙ corresponding to the desired time according to the channel prediction performed in operation 1310.

Referring to (b) of FIG. 13, the UE may further include a predict unit for channel prediction. Here, the predict unit may indicate a separate neural network that performs CSI prediction.

In operation 1325, the UE may use the eigenvector Vₓ according to the currently measured CSI and the eigenvectors Vₓ₋₁ and Vₓ₋₂ according to the CSI measured in the past as inputs to the predict unit. For example, the UE may obtain the values of the channel corresponding to one or more consecutive time from x to x+n using the eigenvectors of the current and past channels, based on the CSI-RS.

In operation 1330, the UE may extract the features by multiplying the eigenvector of the value of the channel obtained in operation 1325 by an orthogonal matrix. For example, the UE may obtain the value by multiplying the eigenvector by the orthogonal matrix and use it as an input to the TSF encoder.

In operation 1335, the UE may use the values obtained through feature extraction as inputs to the encoder according to the AI model. The UE may obtain the compressed latent vector (e.g., Zₓ) through the encoder and transmit a CSI report including the same to the base station. More specifically, through operation 1335, the AI model of the UE may identify correlations between eigenvectors corresponding to the sub-bands (e.g., frequency domain), ranks (e.g., spatial domain), or historical feedbacks (e.g., time domain), respectively. According to various embodiments of the disclosure, the preprocessing operation that highlights the dominant factor of the eigenvector as in operation 1330 may include application of a non-orthogonal matrix in addition to application of an orthogonal matrix (e.g., normalized DFT matrix).

In operation 1340, the base station may use the latent vector included in the CSI report as an input to the decoder according to the AI model and obtain a value reconstructed through the decoder.

In operation 1345, the base station may reconstruct the eigenvector by multiplying the output value of the decoder and the inverse DFE matrix of the DFE matrix. For example, the base station may obtain the reconstructed eigenvector (e.g., \hat{V}ₓ) by multiplying the value reconstructed through the decoder by the inverse matrix of the orthogonal matrix. More specifically, in order to process the eigenvector using the orthogonal matrix, a process is required to map the output value into the form of the eigenvector after the operation of the encoder-decoder. Therefore, operation 1345 may include a process of multiplying the output value of the decoder by the inverse matrix of the matrix used in operation 1330. According to an embodiment of the disclosure, if the base station directly uses the value to which the orthogonal matrix is applied (e.g., precoding, or the like), the process of multiplying the inverse matrix of the orthogonal matrix in operation 1345 may be omitted. Here, the reconstructed eigenvector may include the reconstructed eigenvector \hat{V}ₓ₊ₙ corresponding to the desired time according to the channel prediction performed in operation 1325.

Referring to (c) of FIG. 13, the UE may further include a predict unit for channel prediction. Here, the predict unit may indicate a separate neural network that performs CSI prediction, and may perform channel prediction after the process for feature extraction.

In operation 1350, the UE may extract features by multiplying an eigenvector (e.g., Vₓ) of the channel based on the CSI-RS by an orthogonal matrix. For example, the UE may obtain a value by multiplying the eigenvector by the orthogonal matrix. According to an embodiment of the disclosure, the UE may also apply the same orthogonal matrix to eigenvectors Vₓ₋₁ and Vₓ₋₂ according to the CSI measured in the past. For example, the UE may obtain values by multiplying the current and past eigenvectors by the orthogonal matrix and use them as inputs to the predict unit.

In operation 1355, the UE may use the values obtained through feature extraction as inputs to the predict unit. For example, the UE may use the extracted values of features of the eigenvector Vₓ according to the currently measured CSI and the eigenvectors Vₓ₋₁ and Vₓ₋₂ according to the CSI measured in the past as inputs to the predict unit. For example, the UE may obtain the values of the channel corresponding to one or more consecutive time from x to x+n using the eigenvectors of the current and past channels, based on the CSI-RS.

In operation 1360, the UE may use the values predicted based on the values obtained through feature extraction as inputs to the encoder according to the AI model. The UE may obtain the compressed latent vector (e.g., Zₓ) through the encoder and transmit a CSI report including the same to the base station. More specifically, through operation 1360, the AI model of the UE may identify correlations between eigenvectors corresponding to the sub-bands (e.g., frequency domain), ranks (e.g., spatial domain), or historical feedbacks (e.g., time domain), respectively. According to various embodiments of the disclosure, the preprocessing operation that highlights the dominant factor of the eigenvector as in operation 1350 may include application of a non-orthogonal matrix in addition to application of an orthogonal matrix (e.g., normalized DFT matrix).

In operation 1365, the base station may use the latent vector included in the CSI report as an input to the decoder according to the AI model and obtain a value reconstructed through the decoder.

In operation 1370, the base station may reconstruct the eigenvector by multiplying the output value of the decoder and the inverse DFE matrix of the DFE matrix. For example, the base station may obtain the reconstructed eigenvector (e.g., \hat{V}ₓ) by multiplying the value reconstructed through the decoder by the inverse matrix of the orthogonal matrix. More specifically, in order to process the eigenvector using the orthogonal matrix, a process is required to map the output value into the form of the eigenvector after the operation of the encoder-decoder. Therefore, operation 1370 may include a process of multiplying the output value of the decoder by the inverse matrix of the matrix used in operation 1350. According to an embodiment of the disclosure, if the base station directly uses the value to which the orthogonal matrix is applied (e.g., precoding, or the like), the process of multiplying the inverse matrix of the orthogonal matrix in operation 1370 may be omitted. Here, the reconstructed eigenvector may include the reconstructed eigenvector \hat{V}ₓ₊ₙ corresponding to the desired time according to the channel prediction performed in operation 1355.

According to various embodiments of the disclosure, FIG. 14 illustrate a process of performing AI-based compression and reporting according to Case 4 in Table 1. Case 4 is characterized in that the encoder of the UE performs a process of channel prediction and a process of CSI compression and transmission by considering the time domain, and the decoder of the base station performs a process of CSI reconstruction by considering the time domain. For example, the UE in FIG. 14 may include a TSF encoder (e.g., Predict+TSF encoder) capable of performing compression based on time, space, and frequency domains, including future channel prediction, and the base station may include a TSF decoder capable of performing reconstruction based on time, space, and frequency domains.

Referring to (a) of FIG. 14, in operation 1405, the UE may extract features by multiplying an eigenvector (e.g., Vₓ) of the channel based on the CSI-RS by an orthogonal matrix. For example, the UE may obtain a value by multiplying the eigenvector by the orthogonal matrix. According to an embodiment of the disclosure, the UE may also apply the same orthogonal matrix to the eigenvectors Vₓ₋₁ and Vₓ₋₂ according to the CSI measured in the past. For example, the UE may obtain values by multiplying the current and past eigenvectors by the orthogonal matrix and use them as inputs to the TSF encoder.

In operation 1410, the UE may use the values obtained through feature extraction as inputs to the encoder according to the AI model. The UE may obtain a compressed latent vector (e.g., Zₓ) through the encoder and transmit a CSI report including the same to the base station. More specifically, through operation 1410, the AI model of the UE may identify correlations between eigenvectors corresponding to the sub-bands (e.g., frequency domain), ranks (e.g., spatial domain), or historical feedbacks (e.g., time domain), respectively. The AI model of the UE may expect more efficient learning and improved performance when performing processing using the eigenvector features of the past CSI in addition to the eigenvector features of the current CSI. According to various embodiments of the disclosure, the preprocessing operation that highlights the dominant factor of the eigenvector as in operation 1405 may include application of a non-orthogonal matrix in addition to application of an orthogonal matrix (e.g., normalized DFT matrix).

According to an embodiment of the disclosure, in operation 1410, the UE may predict a value of the channel at future time (x+n), in addition to a value of the channel at the current time (x), through the encoder. For example, the encoder of the UE may predict the values of the channel corresponding to one or more consecutive time from x to x+n, based on the obtained values, and the latent vector may be compressed and produced by further considering such predicted values. Here, the Predic+TSF encoder may indicate a neural network that performs both compression and prediction of the CSI.

In operation 1415, the base station may use the latent vector included in the CSI report as an input to the decoder according to the AI model and obtain a value reconstructed through the decoder. According to an embodiment of the disclosure, the base station may perform decoding by also considering the latent vectors Zₓ₋₁ and Zₓ₋₂ included in the CSI report received in the past. For example, the base station may use the current and past latent vectors as inputs to the TSF decoder.

In operation 1420, the base station may reconstruct the eigenvector by multiplying the output value of the decoder and the inverse DFE matrix of the DFE matrix. For example, the base station may obtain the reconstructed eigenvector (e.g., \hat{V}ₓ) by multiplying the value reconstructed through the decoder by the inverse matrix of the orthogonal matrix. More specifically, in order to process the eigenvector using the orthogonal matrix, a process is required to map the output value into the form of the eigenvector after the operation of the encoder-decoder. Therefore, operation 1420 may include a process of multiplying the output value of the decoder by the inverse matrix of the matrix used in operation 1405. According to an embodiment of the disclosure, if the base station directly uses the value to which the orthogonal matrix is applied (e.g., precoding, or the like), the process of multiplying the inverse matrix of the orthogonal matrix in operation 1420 may be omitted. Here, the reconstructed eigenvector may include the reconstructed eigenvector \hat{V}ₓ₊ₙ corresponding to the desired time according to the channel prediction performed in operation 1410.

Referring to (b) of FIG. 14, the UE may further include a predict unit for channel prediction. Here, the predict unit may indicate a separate neural network that performs CSI prediction, and may perform channel prediction after the process for feature extraction.

In operation 1425, the UE may extract features by multiplying an eigenvector (e.g., Vₓ) of the channel based on the CSI-RS by an orthogonal matrix. For example, the UE may obtain a value by multiplying the eigenvector by the orthogonal matrix. According to an embodiment of the disclosure, the UE may also apply the same orthogonal matrix to eigenvectors Vₓ₋₁ and Vₓ₋₂ according to the CSI measured in the past. For example, the UE may obtain values by multiplying the current and past eigenvectors by the orthogonal matrix and use them as inputs to the predict unit.

In operation 1430, the UE may use the values obtained through feature extraction as inputs to the predict unit. For example, the UE may use the extracted values of features of the eigenvector Vₓ according to the currently measured CSI and the eigenvectors Vₓ₋₁ and Vₓ₋₂ according to the CSI measured in the past as inputs to the predict unit. For example, the UE may obtain the values of the channel corresponding to one or more consecutive time from x to x+n using the eigenvectors of the current and past channels, based on the CSI-RS.

In operation 1435, the UE may use the values predicted based on the values obtained through feature extraction as inputs to the encoder according to the AI model. The UE may obtain the compressed latent vector (e.g., Zₓ) through the encoder and transmit a CSI report including the same to the base station. More specifically, through operation 1435, the AI model of the UE may identify correlations between eigenvectors corresponding to the sub-bands (e.g., frequency domain), ranks (e.g., spatial domain), or historical feedbacks (e.g., time domain), respectively. According to various embodiments of the disclosure, the preprocessing operation that highlights the dominant factor of the eigenvector as in operation 1425 may include application of a non-orthogonal matrix in addition to application of an orthogonal matrix (e.g., normalized DFT matrix).

In operation 1440, the base station may use the latent vector included in the CSI report as an input to the decoder according to the AI model and obtain a value reconstructed through the decoder. According to an embodiment of the disclosure, the base station may perform decoding by also considering the latent vectors Zₓ₋₁ and Zₓ₋₂ included in the CSI report received in the past. For example, the base station may use the current and past latent vectors as inputs to the TSF decoder.

In operation 1445, the base station may reconstruct the eigenvector by multiplying the output value of the decoder and the inverse DFE matrix of the DFE matrix. For example, the base station may obtain the reconstructed eigenvector (e.g., \hat{V}ₓ) by multiplying the value reconstructed through the decoder by the inverse matrix of the orthogonal matrix. More specifically, in order to process the eigenvector using the orthogonal matrix, a process is required to map the output value into the form of the eigenvector after the operation of the encoder-decoder. Therefore, operation 1445 may include a process of multiplying the output value of the decoder by the inverse matrix of the matrix used in operation 1425. According to an embodiment of the disclosure, if the base station directly uses the value to which the orthogonal matrix is applied (e.g., precoding, or the like), the process of multiplying the inverse matrix of the orthogonal matrix in operation 1445 may be omitted. Here, the reconstructed eigenvector may include the reconstructed eigenvector \hat{V}ₓ₊ₙ corresponding to the desired time according to the channel prediction performed in operation 1430.

Referring to (c) of FIG. 14, the UE may further include a predict unit for channel prediction. Here, the predict unit may indicate a separate neural network that performs CSI prediction.

In operation 1450, the UE may use the eigenvector Vₓ according to the currently measured CSI and the eigenvectors Vₓ₋₁ and Vₓ₋₂ according to the CSI measured in the past as inputs to the predict unit. For example, the UE may obtain the values of the channel corresponding to one or more consecutive time from x to x+n using the eigenvectors of the current and past channels, based on the CSI-RS.

In operation 1455, the UE may extract the features by multiplying the eigenvector of the channel value obtained in operation 1450 by an orthogonal matrix. For example, the UE may obtain the value by multiplying the eigenvector by the orthogonal matrix and use it as an input to the TSF encoder.

In operation 1460, the UE may use the values obtained through feature extraction as inputs to the encoder according to the AI model. The UE may obtain the compressed latent vector (e.g., Zₓ) through the encoder and transmit a CSI report including the same to the base station. More specifically, through operation 1460, the AI model of the UE may identify correlations between eigenvectors corresponding to the sub-bands (e.g., frequency domain), ranks (e.g., spatial domain), or historical feedbacks (e.g., time domain), respectively. According to various embodiments of the disclosure, the preprocessing operation that highlights the dominant factor of the eigenvector as in operation 1455 may include application of a non-orthogonal matrix in addition to application of an orthogonal matrix (e.g., normalized DFT matrix).

In operation 1465, the base station may use the latent vector included in the CSI report as an input to the decoder according to the AI model and obtain a value reconstructed through the decoder. According to an embodiment of the disclosure, the base station may perform decoding by also considering the latent vectors Zₓ₋₁ and Zₓ₋₂ included in the CSI report received in the past. For example, the base station may use the current and past latent vectors as inputs to the TSF decoder.

In operation 1470, the base station may reconstruct the eigenvector by multiplying the output value of the decoder and the inverse DFE matrix of the DFE matrix. For example, the base station may obtain the reconstructed eigenvector (e.g., \hat{V}ₓ) by multiplying the value reconstructed through the decoder by the inverse matrix of the orthogonal matrix. More specifically, in order to process the eigenvector using the orthogonal matrix, a process is required to map the output value into the form of the eigenvector after the operation of the encoder-decoder. Therefore, operation 1470 may include a process of multiplying the output value of the decoder by the inverse matrix of the matrix used in operation 1455. According to an embodiment of the disclosure, if the base station directly uses the value to which the orthogonal matrix is applied (e.g., precoding, or the like), the process of multiplying the inverse matrix of the orthogonal matrix in operation 1470 may be omitted. Here, the reconstructed eigenvector may include the reconstructed eigenvector \hat{V}ₓ₊ₙ corresponding to the desired time according to the channel prediction performed in operation 1450.

According to various embodiments of the disclosure, the processes illustrated in FIGS. 13 and 14 show the procedure in which channel prediction is performed only by the UE, but this is only an example, and as described in Table 1 above, various embodiments may also include a model that uses the Predict+TSF decoder or includes the predict unit, and it is obvious that the process for feature extraction may be performed before or after any process in which the AI model operates.

According to various embodiments of the disclosure, in order to perform the feature extraction of the channel and the compression and reconstruction based on the AI model described above, the UE and the base station may exchange information about the AI model in advance. At this time, the AI model used by the UE and the base station may be predefined in the standard, or may be trained by any one of the UE and the base station and then exchanged. For example, the method for aligning AI models between the UE operator or the base station operator may be defined as sharing of data sets, sharing of models or model parameters, or use of standardized information (e.g., a fully standardized reference model (e.g., model structure and parameters) or a standardized data set).

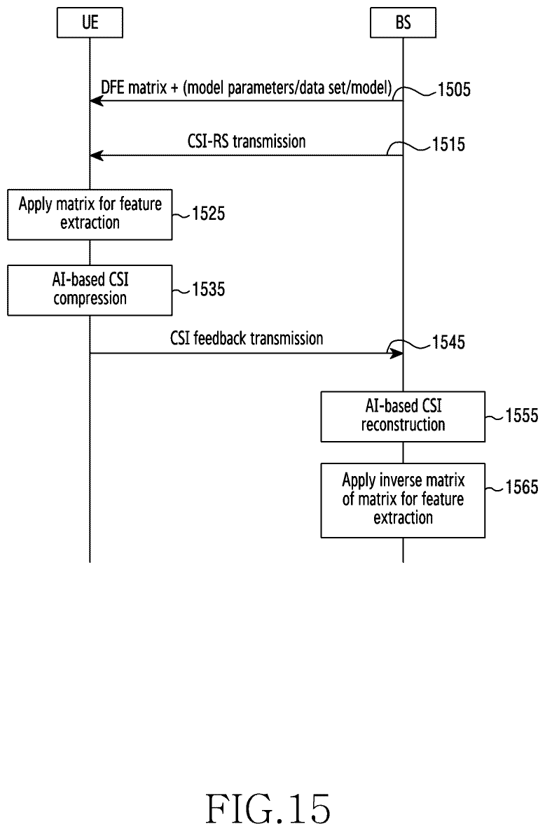

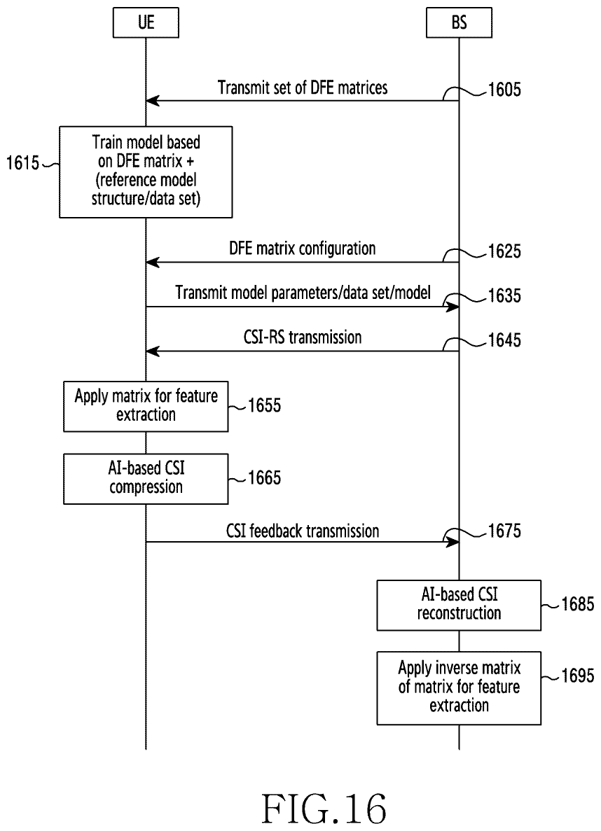

The AI-based CSI compression technology may have the characteristics of a two-sided model that utilizes the inference results of the UE encoder as inputs to the base station decoder. Therefore, due to the characteristics of the two-sided model, alignment between the UE and the network may be required regarding the use or non-use of matrices and inverse matrices for feature extraction or regarding which matrix is to be used when using the same. In addition, according to various embodiments of the disclosure, in addition to the standardized AI model information, the AI-based CSI compression technology may include a network (NW)-side first training method and a UE-side first training method. The network-side first training may indicate a method in which the encoder and decoder of the base station are trained in the base station so that all or some of the training information is shared with the UE, and in which the encoder of the UE is trained to train the AI model through alignment between the models of the encoder of the UE and the decoder of the base station. On the other hand, the UE-side first training may indicate a method in which the encoder and decoder of the UE are trained so that all or some of the training information is shared with the base station, and in which the decoder of the base station is trained to train the AI model through alignment between the models of the encoder of the UE and the decoder of the base station. Hereinafter, a method based on AI model training and sharing between the UE and the base station will be described with reference to FIGS. 15 and 16.

FIG. 15 illustrates a signal flow for performing AI-based CSI compression and reporting based on network-side AI model training according to an embodiment of the disclosure. More specifically, the redundant description between the processes disclosed in FIG. 15 and the processes in FIGS. 7, 8A, 8B, 9A, 9B, 10, 11, 12, 13, and 14 may be omitted, and various embodiments may include combinations of the respective steps. Hereinafter, according to various embodiments of the disclosure, the matrix for feature extraction trained and transmitted by the base station is a DFE matrix for convenience, but this is only an example, and it is obvious that the matrix for feature extraction may include a unitary matrix, an orthogonal matrix, or a non-orthogonal matrix according to the above-described embodiments.

In operation 1505, the base station may transmit, to the UE, at least one of model parameters, a data set, or a reference model, together with information about the DFE matrix. More specifically, the base station may learn/train and determine a matrix for feature extraction or an AI model used for CSI compression and reconstruction in advance, based on the encoder and decoder of the base station, and transmit model information according thereto to the UE.

According to various embodiments of the disclosure, the base station may transmit information about the DFE matrix and information about the model parameters to the UE. At this time, the reference model structure may be defined in advance between the UE and the base station. The information about the DFE matrix transmitted by the base station may include information about whether to use the DFE matrix or information about which type of DFE matrix is to be used. The information about model parameters may include information about weights of the AI model and the like. The information about the DFE matrix may be included in the information about the model parameters. According to an embodiment of the disclosure, the base station may transmit information about a plurality of model parameters. At this time, the DFE matrices included in the plurality of model parameters may be respectively indexed. For example, the base station may separately transmit configuration information including indexes to the UE in order to select a currently used model from among the plurality of model parameters. Alternatively, if an identifier (ID) of the model is predefined, indexing for the respective DFE matrices may be omitted.

According to various embodiments of the disclosure, the base station may transmit the information about the DFE matrix and the information about the data set to the UE. At this time, the format for the data and the data set may be predefined between the UE and the base station. The information about the DFE matrix transmitted by the base station may include information about whether to use the DFE matrix or information about which type of DFE matrix is to be used. The information about the data set may be transmitted to the UE over the air (OTA) or offline. The UE, based on the data set received from the base station, may obtain at least one of information about the backbone of the AI model or information about the weights. Here, only the information about the DFE matrix may be mapped to the data set and transmitted via OTA. According to an embodiment of the disclosure, the base station may transmit information about a plurality of data sets. In this case, the DFE matrices included in the plurality of model parameters may be respectively indexed. For example, the base station may separately transmit configuration information including indexes to the UE in order to select a currently used model from among the plurality of data sets. Alternatively, if an ID of the model is predefined, indexing for each DFE matrix may be omitted.

According to various embodiments of the disclosure, the base station may transmit the information about the DFE matrix and the information about the reference model to the UE. At this time, the format for the model may be predefined between the UE and the base station. The information about the DFE matrix transmitted by the base station may include information about whether to use the DFE matrix or information about which type of DFE matrix is to be used. The information about the reference model may include at least one of information about the structure of the AI model (e.g., information about the backbone of the AI model) and information about the parameters of the AI model (e.g., weights of the AI model). The information about the DFE matrix may also be included in the information about the reference model. According to an embodiment of the disclosure, the base station may transmit information about a plurality of reference models. In this case, the DFE matrices included in the plurality of reference models may be respectively indexed. For example, the base station may separately transmit configuration information including indexes to the UE in order to select a currently used model from among the plurality of reference models. Alternatively, if an ID of the model is predefined, indexing for each DFE matrix may be omitted.

According to various embodiments of the disclosure, although not shown in FIG. 15, after operation 1505, the UE may train the AI model of the UE, based on information (e.g., including at least one of the model parameters, data set, or reference model in addition to the information about the DFE matrix) received from the base station. For example, the UE may include an AI-based encoder for an auto-encoder in advance. The UE may train the AI-based encoder of the UE, based on the AI model information received from the base station. Alternatively, the UE may train the AI-based encoder of the UE, based on the information about the DFE matrix and the AI model information (for example, AI model information to which the DFE matrix is applied). At this time, if the information about the DFE matrix is predefined, the UE may train the AI-based encoder of the UE by receiving only the index or configuration information about the DFE matrix.

Hereinafter, operations 1515 to 1565 may follow the processes described with reference to FIGS. 7, 8A, 8B, 9A, 9B, 10, 11, 12, 13, and 14 above, and redundant descriptions thereof will be omitted.

In operation 1515, the base station may transmit a CSI-RS to the UE. The UE may obtain an eigenvector of the channel, based on the CSI-RS.

In operation 1525, the UE may apply a matrix for feature extraction. The UE may extract features by multiplying the eigenvector of the channel and a DFE matrix. For example, the UE may obtain a value by multiplying the eigenvector and an orthogonal matrix.

In operation 1535, the UE may perform AI-based CSI compression. The UE may use the value obtained through feature extraction as an input to an encoder according to the AI model. The UE may obtain a compressed latent vector through the encoder.

In operation 1545, the UE may transmit CSI feedback to the base station. The UE may transmit a CSI report including the obtained latent vector to the base station.

In operation 1555, the base station may reconstruct the AI-based CSI. The base station may use the latent vector included in the CSI report as an input to a decoder according to the AI model and obtain a reconstructed value through the decoder.

In operation 1565, the base station may apply the inverse matrix of a matrix for feature extraction. The base station may reconstruct the eigenvector by multiplying the output value of the decoder and the inverse DFE matrix of the DFE matrix. For example, the base station may obtain the reconstructed eigenvector by multiplying the value reconstructed through the decoder and the inverse matrix of the orthogonal matrix.

Not all of the respective steps disclosed in FIG. 15 are essential, and various embodiments may include at least one of all, some, or a combination of the steps in FIG. 15. For example, if the AI model is predefined between the UE and the base station, the respective steps may be performed without performing operation 1505, or the order of the steps may vary as illustrated in FIG. 12. For example, according to various embodiments of the disclosure, each of the steps of FIG. 15 may be changed or deleted according to FIGS. 7, 8A, 8B, 9A, 9B, 10, 11, 12, 13, and 14 described above, or unillustrated steps may be added thereto. In addition, although not shown in FIG. 15, it is obvious that the UE and the base station may perform in advance a process of exchanging UE capability information regarding AI model usage or CSI feedback mode instruction information.

FIG. 16 illustrates a signal flow for performing AI-based CSI compression and reporting based on AI model training in the UE according to an embodiment of the disclosure. More specifically, the redundant descriptions between the processes disclosed in FIG. 16 and the processes in FIGS. 7, 8A, 8B, 9A, 9B, 10, 11, 12, 13, and 14 may be omitted, and various embodiments may include combinations of the respective steps. Hereinafter, according to various embodiments of the disclosure, the matrix for feature extraction trained and transmitted by the base station is a DFE matrix for convenience, but this is only an example, and it is obvious that the matrix for feature extraction may include a unitary matrix, an orthogonal matrix, or a non-orthogonal matrix according to the above-described embodiments.

In operation 1605, the base station may transmit a set of DFE matrices to the UE. More specifically, the base station may transmit information about a set including one or more DFE matrices to the UE. At this time, a plurality of DFE matrices included in the set may be respectively indexed. According to an embodiment of the disclosure, the set of DFE matrices transmitted by the base station to the UE may include at least one of information about a rank or information about a feedback bit size for each matrix (e.g., corresponding to each matrix). According to an embodiment of the disclosure, the set of DFE matrices transmitted by the base station to the UE may be transmitted through at least one of upper layer signaling, such as RRC signaling, MAC control element (CE), or downlink control information (DCI).

In operation 1615, the UE may train a model including a DFE matrix, a reference model structure to which a DFE matrix is applied, or a data set to which a DFE matrix is applied. More specifically, the UE may learn/train and determine a matrix for feature extraction or an AI model used for CSI compression and reconstruction, based on the encoder and decoder of the UE.

In operation 1625, the base station may transmit information for configuring a DFE matrix to the UE. More specifically, the base station may transmit configuration information associated with the DFE matrix for feature extraction to the UE. At this time, the configuration information may include indication information for indicating some DFE matrices among the set of DFE matrices transmitted by the base station in operation 1605, and the indication information may include an indicator based on an index. Here, the indication information for indicating a DFE matrix may include an index indicating the case where the DFE matrix is not used (for example, an indicator indicating legacy training). According to an embodiment of the disclosure, the base station may transmit information for configuring a DFE matrix by rank or information for configuring a DFE matrix by feedback bit size to the UE. According to an embodiment of the disclosure, the configuration information transmitted by the base station to the UE may be transmitted via at least one of the upper layer signaling, such as RRC signaling, MAC CE, or DCI. According to an embodiment of the disclosure, the UE receiving information for configuring the DFE matrix may train the AI model of the UE using only the configured DFE matrix. For example, the UE may include an AI-based encoder for an auto-encoder in advance. The UE may train the AI-based encoder in the UE, based on the information about the DFE matrix configured by the base station. When training the AI model, based on the configuration information of the DFE matrix described above, the training process of the AI model performed in the previous steps (e.g., operation 1605 or operation 1615) may be omitted.

In operation 1635, the UE may transmit, to the base station, at least one of the trained model parameters, data sets, or reference models together with the information about the DFE matrix. More specifically, the UE may train and determine, in advance, the AI model used for CSI compression and reconstruction to which a matrix for feature extraction is applied, based on the encoder and decoder of the UE, and transmit, to the base station, model information according thereto.

According to various embodiments of the disclosure, the base station may transmit information about model parameters to which the DFE matrix is applied to the UE. At this time, the reference model structure may be predefined between the UE and the base station. The information about the model parameters transmitted by the UE may include model parameters corresponding to the configuration information transmitted by the base station in operation 1625. The information about the model parameters may include information about the weights of the AI model and the like. Operation 1635 may correspond to operation 1505 in FIG. 15.

According to various embodiments of the disclosure, the base station may transmit information about the data set to which the DFE matrix is applied to the UE. At this time, the format for the data and data set may be predefined between the UE and the base station. The information about the data set transmitted by the UE may include a data set corresponding to the configuration information transmitted by the base station in operation 1625. The information about the data set may be transmitted to the base station through OTA or offline. The base station may obtain at least one of information about the backbone of the AI model or information about the weights, based on the data set received from the UE. Here, only information about the DFE matrix may be mapped to the data set and transmitted through OTA. Operation 1635 may correspond to operation 1505 in FIG. 15.

According to various embodiments of the disclosure, the base station may transmit information about a model to which the DFE matrix is applied to the UE. At this time, the format for the model may be predefined between the UE and the base station. The information about the model transmitted by the UE may include a model corresponding to the configuration information transmitted by the base station in operation 1625. The information about a reference model may include at least one of information about the structure of the AI model (e.g., the backbone of the AI model) and information about the parameters of the AI model (e.g., the weights of the AI model). Operation 1635 may correspond to operation 1505 in FIG. 15.

Subsequent processes of operations 1645 to 1695 may follow the processes specifically described in FIGS. 7, 8A, 8B, 9A, 9B, 10, 11, 12, 13, and 14 above, and redundant descriptions thereof will be omitted.

In operation 1645, the base station may transmit a CSI-RS to the UE. The UE may obtain an eigenvector of the channel, based on the CSI-RS.

In operation 1655, the UE may apply a matrix for feature extraction. The UE may extract features by multiplying the eigenvector of the channel and a DFE matrix. For example, the UE may obtain a value by multiplying the eigenvector and an orthogonal matrix.

In operation 1665, the UE may perform AI-based CSI compression. The UE may use the value obtained through feature extraction as an input to an encoder according to the AI model. The UE may obtain a compressed latent vector through the encoder.

In operation 1675, the UE may transmit CSI feedback to the base station. The UE may transmit a CSI report including the obtained latent vector to the base station.

In operation 1685, the base station may reconstruct the AI-based CSI. The base station may use the latent vector included in the CSI report as an input to a decoder according to the AI model, and obtain a reconstructed value through the decoder.

In operation 1695, the base station may apply the inverse matrix of the matrix for feature extraction. The base station may reconstruct the eigenvector by multiplying the output value of the decoder and the inverse DFE matrix of the DFE matrix. For example, the base station may obtain the reconstructed eigenvector by multiplying the value reconstructed by the decoder and the inverse matrix of the orthogonal matrix.

Not all of the respective steps disclosed in FIG. 16 are essential, and various embodiments may include at least one of all, some, or a combination of the steps in FIG. 16. For example, if the AI model is predefined between the UE and the base station, the respective steps may be performed without performing operations 1605 to 1635, or the order of the steps may vary as illustrated in FIG. 12. For example, according to various embodiments of the disclosure, each of the steps of FIG. 16 may be changed or deleted according to FIG. 7, 8A, 8B, 9A, 9B, 10, 11, 12, 13, and 14 described above, or unillustrated steps may be added thereto. In addition, although not shown in FIG. 16, it is obvious that the UE and the base station may perform in advance a process of exchanging UE capability information regarding AI model usage or CSI feedback mode instruction information.

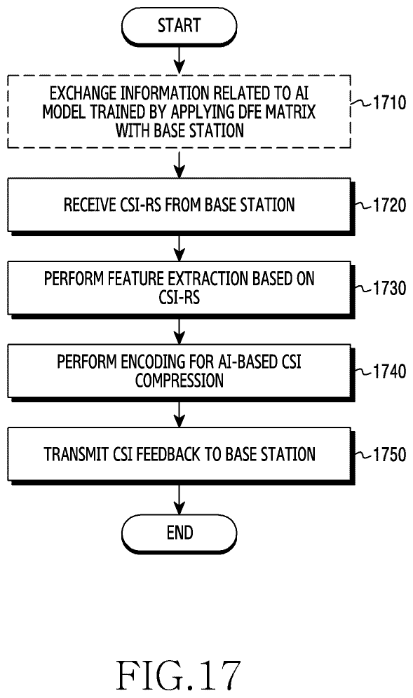

FIG. 17 illustrates an operation flow of a UE for performing AI-based CSI compression and reporting based on feature extraction of an eigenvector according to an embodiment of the disclosure. More specifically, the redundant descriptions between the processes disclosed in FIG. 17 and the processes in FIGS. 7, 8A, 8B, 9A, 9B, 10, 11, 12, 13, 14, 15, and 16 may be omitted, and various embodiments may include combinations of the respective steps.

In operation 1710, the UE may exchange information related to the AI model trained by applying a DFE matrix with the base station. The training process for the AI model used by the UE and the base station is described with reference to FIG. 15 for network-side first training and FIG. 16 for UE-side first training. According to an embodiment of the disclosure, if the AI model is previously defined between the UE and the base station, operation 1710 may be omitted.

In operation 1720, the UE may receive a CSI-RS from the base station. The UE may obtain an eigenvector of the channel, based on the CSI-RS.

In operation 1730, the UE may perform feature extraction, based on the CSI-RS. For example, the UE may apply a matrix for feature extraction, based on the CSI-RS. The UE may extract features by multiplying the eigenvector of the channel and a DFE matrix. For example, the UE may obtain a value by multiplying the eigenvector by an orthogonal matrix.

In operation 1740, the UE may perform encoding for AI-based CSI compression. The UE may use the value obtained through feature extraction as an input to an encoder according to the AI model. The UE may obtain a compressed latent vector through the encoder.

In operation 1750, the UE may transmit CSI feedback to the base station. The UE may transmit a CSI report including the obtained latent vector to the base station.

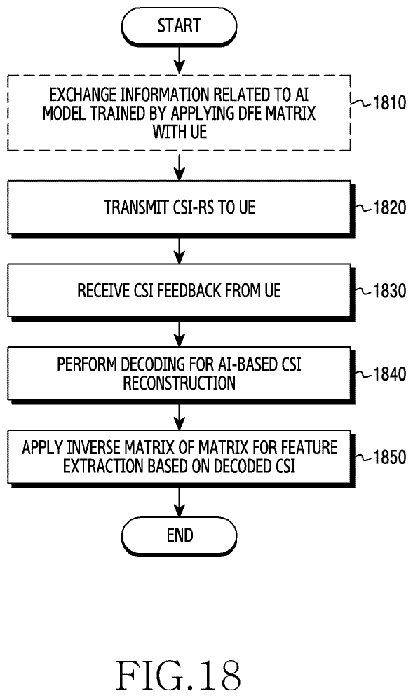

FIG. 18 illustrates an operation flow of a base station for performing AI-based CSI compression and reporting based on feature extraction of an eigenvector according to an embodiment of the disclosure. More specifically, the redundant descriptions between the processes disclosed in FIG. 18 and the processes in FIGS. 7, 8A, 8B, 9A, 9B, 10, 11, 12, 13, 14, 15, and 16 may be omitted, and various embodiments may include combinations of the respective steps.

In operation 1810, the base station may exchange information related to an AI model trained by applying a DFE matrix with the UE. The training process for the AI model used by the UE and the base station is described with reference to FIG. 15 for network-side first training and FIG. 16 for UE-side first training. According to an embodiment of the disclosure, if the AI model is previously defined between the UE and the base station, operation 1810 may be omitted.

In operation 1820, the base station may transmit a CSI-RS to the UE. The UE may obtain an eigenvector of the channel, based on the CSI-RS.

In operation 1830, the base station may receive CSI feedback from the UE. The base station may receive a CSI report including a latent vector produced by performing AI-based CSI compression from the UE.

In operation 1840, the base station may perform decoding for reconstruction of the AI-based CSI. The base station may use the latent vector included in the CSI report as an input to the decoder according to the AI model, and may obtain a value reconstructed through the decoder.

In operation 1850, the base station may perform feature extraction, based on the decoded CSI. The base station may apply the inverse matrix of a matrix for feature extraction to the value reconstructed through the decoder. The base station may reconstruct the eigenvector by multiplying the output value of the decoder and the inverse DFE matrix of the DFE matrix. For example, the base station may obtain the reconstructed eigenvector by multiplying the value reconstructed through the decoder and the inverse matrix of an orthogonal matrix.

As described above, various embodiments according to the disclosure may enable efficient learning and improved performance of AI-based CSI compression technology through feature extraction of an eigenvector, thereby bringing about effects of improving the reconstruction performance, reducing feedback overhead, and increasing cell throughput.

TABLE 2

| | Original | DFT | Random Unitary |
|---|---|---|---|
| STD | 0.024 | 0.075 | 0.03 |

TABLE 3

| ENC | DEC | w/DFE | w/o DFE | Gain (%) |
|---|---|---|---|---|
| Dense1 | Dense1 | 0.725 | 0.716 | 1.3 |
| TF22 | TF22 | 0.734 | 0.729 | 0.7 |

TABLE 4

| ENC | DEC | w/DFE | w/o DFE | Gain (%) |
|---|---|---|---|---|
| Dense1 | Dense1 | 0.631 | 0.604 | 4.5 |
| TF22 | TF22 | 0.661 | 0.659 | 0.3 |

Table 2 and Table 3 show simulation results of comparing the results of training AI through eigenvector feature extraction according to the embodiments of the disclosure with the legacy method.

Table 2 shows the results of calculating the standard deviation (STD) of the matrix elements when using a DFT matrix, which is one of the methods for extracting eigenvector features, as preprocessing of the input, compared to the legacy method. Compared to when the eigenvector is preprocessed using the legacy method or the random unitary matrix, the standard deviation may increase by about 2 to 3 times when the DFT matrix is used, which may indicate that the values of key information have changed to a form that is easy for AI model learning (for example, a form that is more prominent in a specific element).

Table 3 and Table 4 show the performance results of Rank 1 squared generalized cosine similarity (SGCS) and Rank 2 SGCS, respectively. Referring to Table 3 and Table 4, the SGCS performance may have an advantage when feature extraction using DFE matrix is applied to each auto-encoder, based on the transformer backbone (e.g., TF22) and CNN backbone (e.g., Dense1), compared to the case where it is not applied.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including random access memory and flash memory, read only memory (ROM), electrically erasable programmable read only memory (EEPROM), magnetic disc storage device, compact disc-ROM (CD-ROM), digital versatile discs (DVDs), or other type optical storage devices, or a magnetic cassette. Alternatively, any combination of some or all of them may form memory in which the program is stored. In addition, a plurality of such memories may be included in the electronic device.

Furthermore, the programs may be stored in an attachable storage device which can access the electronic device through communication networks, such as the Internet, Intranet, local area network (LAN), wide LAN (WLAN), and storage area network (SAN) or a combination thereof. Such a storage device may access the electronic device via an external port. In addition, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A user equipment (UE) in a wireless communication system, the UE comprising:
a transceiver; and
a controller coupled with the transceiver, and configured to:
receive a first channel state information (CSI)-reference signal (RS) from a base station at first time,
apply a matrix for feature extraction to a first eigenvector value according to the first CSI-RS to perform the feature extraction,
perform encoding for artificial intelligence (AI)-based CSI compression, based on a value according to the feature extraction, and
transmit feedback according to the AI-based CSI compression to the base station.

2. The UE of claim 1, wherein the matrix for feature extraction comprises a unitary matrix or a non-orthogonal matrix produced based on the unitary matrix.

3. The UE of claim 1, wherein the feature extraction is performed by applying the matrix for feature extraction to the first eigenvector value and a second eigenvector value according to a second CSI-RS received at second time prior to the first time.

4. The UE of claim 3,
wherein the controller is further configured to perform channel prediction, based on the first eigenvector value and the second eigenvector value, and
wherein the feature extraction is performed based on a value produced according to the channel prediction.

5. The UE of claim 1, wherein a model for the AI-based CSI compression based on the matrix for feature extraction is trained by the base station or the UE.

6. A base station in a wireless communication system, the base station comprising:
a transceiver; and
a controller coupled with the transceiver, and configured to:
transmit a first channel state information (CSI)-reference signal (RS) to a user equipment (UE) at first time,
receive, from the UE, first feedback in which encoding for AI-based CSI compression is performed based on a value obtained by applying a matrix for feature extraction to an eigenvector value according to the first CSI-RS,
perform decoding for artificial intelligence (AI)-based CSI reconstruction, based on the first feedback, and
apply an inverse matrix of the matrix for feature extraction to the decoded feedback value.

7. The base station of claim 6, wherein the matrix for feature extraction comprises a unitary matrix or a non-orthogonal matrix produced based on the unitary matrix.

8. The base station of claim 6, wherein the decoding is performed based on the first feedback and second feedback according to a second CSI-RS transmitted at second time prior to the first time.

9. The base station of claim 8, wherein the encoding for CSI compression is performed based on a value obtained by applying the matrix for feature extraction to a value produced according to channel prediction based on the first CSI-RS and the second CSI-RS.

10. The base station of claim 6, wherein a model for the AI-based CSI reconstruction based on the matrix for feature extraction is trained by the base station or the UE.

11. A method performed by a user equipment (UE) in a wireless communication system, the method comprising:
receiving a first channel state information (CSI)-reference signal (RS) from a base station at first time;
applying a matrix for feature extraction to a first eigenvector value according to the first CSI-RS to perform the feature extraction;
performing encoding for artificial intelligence (AI)-based CSI compression, based on a value according to the feature extraction; and
transmitting feedback according to the AI-based CSI compression to the base station.

12. The method of claim 11, wherein the matrix for feature extraction comprises a unitary matrix or a non-orthogonal matrix produced based on the unitary matrix.

13. The method of claim 11, wherein the feature extraction is performed by applying the matrix for feature extraction to the first eigenvector value and a second eigenvector value according to a second CSI-RS received at second time prior to the first time.

14. The method of claim 13, further comprising:
performing channel prediction, based on the first eigenvector value and the second eigenvector value,
wherein the feature extraction is performed based on a value produced according to the channel prediction.

15. The method of claim 11, wherein a model for the AI-based CSI compression based on the matrix for feature extraction is trained by the base station or the UE.

16. A method performed by a base station in a wireless communication system, the method comprising:
transmitting a first channel state information (CSI)-reference signal (RS) to a user equipment (UE) at first time;
receiving, from the UE, first feedback in which encoding for artificial intelligence (AI)-based CSI compression is performed based on a value obtained by applying a matrix for feature extraction to an eigenvector value according to the first CSI-RS;
performing decoding for AI-based CSI reconstruction, based on the first feedback; and
applying an inverse matrix of the matrix for feature extraction to the decoded feedback value.

17. The method of claim 16, wherein the matrix for feature extraction comprises a unitary matrix or a non-orthogonal matrix produced based on the unitary matrix.

18. The method of claim 16, wherein the decoding is performed based on the first feedback and second feedback according to a second CSI-RS transmitted at second time prior to the first time.

19. The method of claim 18, wherein the encoding for CSI compression is performed based on a value obtained by applying the matrix for feature extraction to a value produced according to channel prediction based on the first CSI-RS and the second CSI-RS.

20. The method of claim 16, wherein a model for the AI-based CSI reconstruction based on the matrix for feature extraction is trained by the base station or the UE.
